(19) United States
(12) Patent Application Publication
(10) Pub. No.: US 2005/0003870 A1
(43) Pub. Date: Jan. 6, 2005

(54) Information terminal and program for processing displaying information used for the same

(75) Inventors: Masao Nakano, Yokohama-shi (JP); Masao Nakazawa, Yokohama-shi (JP); Yoshio Sasaki, Kawasaki-shi (JP); Eiji Takeuchi, Yokohama-shi (JP); Yosuke Miho, Yokohama-shi (JP); Hajime Ishikawa, Yokohama-shi (JP); Takeo Kobayashi, Yokohama-shi (JP); Tomoki Myoi, Kawasaki-shi (JP); Hiroshi Kasakawa, Yokohama-shi (JP); Akiko Watanabe, Tokyo (JP); Shinsuke Sata, Kanagawa-ken (JP)

Correspondence Address: SCHULTE ROTH & ZABEL LLP, 919 Third Avenue, New York, NY, 10022, US

(73) Assignee: KYOCERA CORPORATION

(21) Appl. No.: 10/609,717

(22) Filed: Jun. 27, 2003

(30) Foreign Application Priority Data
Jun. 28, 2002 (JP) 2002-191121
Jun. 28, 2002 (JP) 2002-191122
Jul. 30, 2002 (JP) 2002-221745
Jul. 31, 2002 (JP) 2002-222318

(51) Int. Cl. H04M 1/00; H04B 1/38

(52) U.S. Cl. 455/575.1; 455/556.2; 455/566

(57) ABSTRACT

A plurality of tabs are arrayed in a predetermined direction on a screen page. Every time a control switch supported so as to be capable of oscillating within a predetermined range and capable of pushing is pushed, a tab sequentially selected is shifted and activated. A setting screen page is displayed. When a part of a plurality of tabs are displayed on a screen page, a tab appears on the screen may be sequentially changed by pushing operation of the control switch part. In this manner, a tab is pointed, selected and determined only by operation of the control switch part.

### BACKGROUND OF THE INVENTION

1. Field of the Invention

The present invention relates to an information terminal which processes an item selected from a plurality of items defined on a screen page or processes at least one item selected in one lump and a program for processing displaying information used for the same, particularly to a personal digital assistant (PDA) provided with these functions.

2. Description of the Related Art

Generally, as for information terminals, an apparatus capable of selecting a requested menu item from a plurality of menu items by rotating a dial switch, such as a rotary switch are well known. For example, Japanese patent publication JP2000-312252A (hereinafter referred to as a prior art 1-1) discloses a PDC and a method for inputting data into the same, in which a left dial input device and a right dial input device are provided on the sides thereof. Menu items on the screen are scrolled up and down by rotating operation of either of the left or the right dial input device for selecting a menu item by pushing operation of the dial input device, whereby transferring to another menu on the screen which shown on the lower hierarchical layer.

Japanese patent publication JP1998-240693A (hereinafter referred to as a prior art 1-2) discloses a PDC wherein a scrolling direction is changed as to whether the screen is viewed in a longitudinal way (a longitudinal mode) or a transversal way (a transversal mode) so that displayed contents can be scrolled by operating a single rotary switch in either display mode of the longitudinal mode or transversal mode.

In Japanese patent publication JP2001-188656A (hereinafter referred to as a prior art 1-3), it is described that a candidate item displayed on a screen is selected by rotating operation of a dial capable of pushing and the selected candidate item is determined by pushing operation of the dial capable of pushing so as to proceed with kinds of processes according to the selected candidate item.

Further, in Japanese patent publication JP2001-151774A (hereinafter referred to as a prior art 1-4), it is described that a rotary switch and a push button are provided for selecting a data displayed on a liquid crystal screen by rotating operation of the rotary switch and determining the data by pushing operation of the push button.

In the prior art 1-1 stated above, items on the screen are scrolled to select by rotating operation of the rotary switch and the pointed item is determined by one pushing operation of the rotary switch and no more. Devices other than the rotary switch, such as a touch device, are necessary for other operations on the screen because the rotary switch is not designed so as to be used for other operations.

As for operation of rotary and pushing switches described in the prior arts 1-2 to 1-4, likewise the prior art 1-1, only an operation of scrolling for selecting and pushing for determining is capable so that no other operation can be done with the rotary switches. Thus, there is a problem in the prior arts 1-1 to 1-4 that a variety of operations are not possible with a single rotary switch.

Meanwhile, there is an information terminal with a memory in which a plurality of information (such as a group of files) can be stored. Attribute information corresponding to each information such as a file name, a file size, a creation date and others are displayed in one lump on a screen as a list of attribute information by means of a predetermined input operation. When a desired attribute information is selected from the list of attribute information on the screen, a predetermined processing is executed as to the information concerning said selected attribute information. For example, if a predetermined processing is a delete processing, an information (e.g. a file itself) concerning the selected attribute information is deleted from the memory by selecting a desired attribute information on the list.

For example, when an information is deleted as stated above, an attribute information pertaining to the information desired to be deleted is selected by means of a point operation such as a point operation with a pointing device such as a mouse or a touch operation (tap operation) on a touch panel. After that, the information concerning the selected attribute information is deleted from the memory by touching a delete button.

In case a processing other than deletion such as startup is executed, after an attribute information pertaining to the information desired to be processed is selected by means of a touch operation or the like, the information concerning the selected attribute information is processed by touching a button having a desired processing function. Further, there is one in which after a series of plural items of the attribute information are dragged to select at one time, the information concerning the selected series of plural items of attribute information are efficiently deleted from the memory by touch operation.

In order to select a desired attribute information from a list of attribute information and delete or startup the information concerning the selected attribute information in the above described information terminal, an attribute information pertaining to the information desired to be processed is selected by touch operation and after that the information concerning the selected attribute information is processed by touching a button having a desired processing function. That is, in order to execute a similar processing as to a plurality of items of attribute information, an item of attribute information is selected from a list of attribute information on the screen by touch operation or the like and after that, a button having a desired processing function is touched and after back to the list of attribute information on the screen again, another item of attribute information is selected from the list, a button having a desired processing function is touched again. These operations need to be repeated.

When a plurality of items of information need to be deleted from a memory, after an item of attribute information pertaining to the information desired to be deleted is selected on a list of attribute information on a screen, a delete button is touched and again after another item of attribute information pertaining to the information desired to be deleted is selected on the list of attribute information on the screen, the delete button is touched again. These operations need to be repeated. Or, after a series of plural items of the attribute information are dragged to select, the delete button needs to be touched for deleting.

As stated above, in a conventional information terminal, when a similar processing is executed for a plurality of items of information, selecting and processing operations need to be repeated so that a problem of bad operationality arises. Moreover, when a similar processing is executed after selecting a series of items of attribute information, only a consecutive series of items can be selected but an arbitrary series of items can not be selected. With this point, operationality is extremely bad.

In another conventional information terminal, a scroll function is provided for scrolling a screen page (a display screen image). The scroll function assigns, for example, a line scroll function for scrolling one line by one line or a jumping function for jumping to anteroposterior screen pages in page unit to a predetermined key operation.

Meanwhile, there is a mobile information terminal with a jog dial in which selection items of a line scroll or a screen scroll are displayed on a screen and the line scroll is selected by rotating the jog dial upward or the screen scroll is selected by rotating the jog dial downward. That is, a scroll mode is selected according to the rotational direction of the jog dial. In this state (the state the jog dial has been rotated upward or downward), jog dial is pushed down vertically so that the scroll mode is determined for being stored into a RAM. (Japanese patent publication JP11-161402A (hereinafter referred to as a prior art 3-1))

When a scroll processing action is executed, by rotation of the jog dial, its interruption is recognized so that a scroll mode stored in the RAM is checked. If the scroll mode is a line scroll mode, the jog dial scrolls for a line in the direction of up or down according to its rotational direction. While, if the scroll mode stored in the RAM is a screen page scroll mode, the jog dial scrolls for a screen page in the direction of up or down according to its rotational direction.

Further, Japanese patent publication JP2000-194492A (hereinafter referred to as a prior art 3-2) discloses an apparatus for recording and reproducing screen images in which when a screen image scroll mode is selected as a scroll function, it is detected whether a jog dial is pushed or not; if the jog dial is rotated in the state that the jog dial is not pushed, an image data displayed on the screen is scrolled in the direction of x axis; if the jog dial is rotated in the state that the jog dial is pushed, an image data displayed on the screen is scrolled in the direction of y axis.

In Japanese patent publication JP10-240693A (hereinafter referred to as a prior art 3-3), a scrolling direction is changed as to whether the screen is viewed in a longitudinal way (a longitudinal mode) or a transversal way (a transversal mode) so that displayed contents can be scrolled by operating instinctively a single rotary switch in either display mode of the longitudinal mode or transversal mode.

In Japanese patent publication JP2000-47791A (hereinafter referred to as a prior art 3-4), an apparatus has a first and second buttons wherein if the first and second buttons are simultaneously pushed, a longitudinal scroll mode is changed to a transversal scroll mode or vice versa; if the first or second button is pushed, letters displayed on the screen are scrolled in the forward direction or backward direction. Selected letters input is determined by shift operation of the first and the second button.

There is another apparatus having a scroll function that a cursor is moved transversely by long pushing operation of an up key and down key in a transversal mode and a cursor is moved longitudinally by pushing operation of an up key and down key in a longitudinal mode (Japanese patent publication JP2001-94654A or JP2001-103143A)

There is yet another apparatus in which, when a browser's screen image is operated, a moving direction of the browser's screen image is determined based on phases of tow pulses generated by rotational directions of an input part of up-down move and an input part of right-left move while a moving speed of the browser's screen image is determined based on pulse number generated by rotational speed. (Japanese patent publication JP2002-207084A).

There is yet another apparatus in which a screen page is scrolled up and down by rotating a roller part provided on a operating face of the remote controller and a screen page is scrolled right and left by pushing a left or right upper part of the roller part. For example, Japanese patent publication JP11-203985.

In the above prior art 3-1, after a screen image of the list containing ‘line scroll’ and ‘screen scroll’ is displayed as a selection items, the determined scroll mode needs to be stored in a RAM. Every time the scroll mode is changed, the above stated display operation, selection operation, determining operation, and storing need to be conducted, which results in very bad operationality.

Particularly, the above mentioned changing operation of scroll mode for an information terminal used on mobile circumstances leads to extreme unavailability.

In the prior art 3-2, a screen image data is scrolled in the direction of x axis by rotating the jog dial of non-pushed state and a screen image data is scrolled in the direction of y axis by rotating the jog dial of pushed state, that is, while pushing operation, rotating operation needs to be conducted. Such simultaneous two operations leads to extreme unavailability either.

Particularly, the above mentioned simultaneous two operations for an information terminal used on mobile circumstances such as PDAs leads to extreme unavailability.

In the prior art 3-3, though a scroll direction is changed depending on a longitudinal view mode or a transversal view mode and the screen is scrolled up and down by operating the rotary switch in each state of a longitudinal view or a transversal view, the scroll direction is not change to the right and left direction in either case of a longitudinal view mode or a transversal view mode. Thus, the screen is only capable of scrolling up and down in either mode, which results in bad operationality.

In the prior art 3-4, though it is described that a scroll direction is controlled by changing a scroll mode according to an operational state of a first and/or second button, the first and second buttons need to be operated simultaneously, which results in bad operationality. Particularly, the above mentioned combined operations of two buttons for an information terminal using on mobile circumstances such as PDAs leads to extreme unavailability.

As mentioned above, any of the prior arts 3-1to 3-4, have a problem that operationality of controlling a screen display such as a scroll function is very bad.

Generally, an information terminal in which a desired menu item is selected from a plurality of menu items by rotating a dial switch such as a rotary switch is well known. Japanese patent publication JP2000-312252A discloses an apparatus having a left input dial device and a right input dial device on the lateral faces of the apparatus wherein menu items are scrolled up and down by rotating operation of either one of the dial devices and the an item is transferred to the lower hierarchical layer.

In the prior art, information is arrayed as a matrix on a screen, lines of which is scrolled by a main dial that is either one of the left or right dial and columns of which is scrolled by a sub dial that is another of the left or right dial. A selective letter is reached by operating the main dial and the sub dial in order to select one of plurality of information arrayed as a matrix.

In Japanese patent publication JP10-240693A, a scroll direction is changed depending on whether the current mode is a longitudinal view mode or a transversal view mode so as to scroll displayed contents by operating a single rotary switch irrespective of a longitudinal or transversal view mode. In Japanese patent publication JP2001-188656A, it is described that a candidate item displayed on a screen is selected by rotating operation of a dial capable of pushing and the selected candidate item is determined by pushing operation of the dial capable of pushing so as to proceed with kinds of processes according to the selected candidate item. Further, in Japanese patent publication JP2000-151774A, it is described that, provided with a rotary switch and a push button, a data is selected by rotating operation of the rotary switch and the data is determined by pushing operation of the push button.

There is an information terminal wherein a plurality of items are arrayed on a displayed screen and if one of the items is selected, a list of information related to the selected item is displayed as a string of information. For example, in an address book, ‘all’, ‘a’, ‘b’, ‘c’, . . . ‘z’ and ‘others’ are arrayed as a plurality of items and if one of the items is selected (e.g. by touch operation), a list of information related to the selected item (names) is displayed on the screen.

When ‘a’ is selected as an item, a name list beginning with ‘a’ is displayed. If one of names beginning with ‘a’ is selected (e.g. by tap operation), a detailed list of information related to said name (address, telephone number and other personal information) is displayed on the screen.

Since an information terminal, particularly a PDA, is used in mobile circumstances, it is necessary to operate with a single hand. For this reason, selecting operation needs to be simplified when detailed personal information is inspected from the address book.

However, in the above mentioned prior arts, when one of a plurality of items arrayed on the displayed screen is selected as a selected item for displaying the information related to the selected item as the string information, a plurality of dial switches need to be operated so that the operation becomes extremely complicated.

### SUMMARY OF THE INVENTION

A first object of the present invention is to provide a portable information terminal having an excellent operationality capable of operating a variety of operations with a single switch. A second object of the present invention is to provide an information terminal having an excellent operationality of selecting information stored in a memory and a program for processing displaying information used for the same. A third object of the present invention is to provide an information terminal which can be easily operated and has an excellent operationality and a program for processing displaying information used for the same. A forth object of the present invention is to provide an information terminal having an excellent operationality wherein, when one of a plurality of items arrayed on a displayed screen is selected as a selected item, operation for displaying the information related to the selected item can be easily conducted and a program for processing displaying information used for the same.

According to the present invention, an information terminal comprises a control switch part capable of oscillating operation or rotating operation and pushing operation and a display part displaying a plurality of items wherein one item is sequentially selected from the items every time the control switch is pushed.

According to the present invention, a plurality of the items are a plurality of tabs arrayed in a predetermined direction and a tab is sequentially selected along a predetermined direction every time the control switch is pushed.

According to the present invention, an information terminal comprises a control switch part capable of oscillating operation or rotating operation and pushing operation, a display part capable of displaying a plurality of tabs having at least one item wherein a tab is selected along the right and left direction by pushing operation of the control switch part and a cursor is transferred to at least one item, which the selected tab has, by oscillating operation or rotating operation of the control switch part so as to select a selected item by pushing operation of the control switch part at the position of the cursor.

According to the present invention, an information terminal comprises a control switch part capable of oscillating operation or rotating operation and pushing operation, a display part displaying a plurality of items as a two dimensional array, a first selection control means selecting one item from a plurality of the items along one direction of the two dimensional array by oscillating operation or rotating operation of the control switch part, and a second selection control means selecting one item along another different direction of the two dimensional array by pushing operation of the control switch part.

According to the present invention, a plurality of the items are a plurality of tabs wherein the first selection control means selects sequentially the tab along up and down direction every oscillating operation or rotating operation of the control switch part and the second selection control means selects sequentially the tab along right an left direction every pushing operation of the control switch part.

According to the present invention, an information terminal comprises a control switch part capable of oscillating operation or rotating operation and pushing operation, a display part capable of displaying a first screen page displaying a plurality of items as a one-dimensional array and second screen page displaying a plurality of items as a two-dimensional array, a first selection control means selecting one item from a plurality of the items along the direction of the array on the first screen page by oscillating operation or rotating operation of the control switch part, a second selection control means selecting one item from a plurality of the items along one direction of the array on the second screen page by pushing operation of the control switch part, and a transfer means transferring the first screen page to the screen page related to the item selected by oscillating operation or rotating operation of the control switch part by means of pushing operation of the control switch part.

According to the present invention, the first screen page is a menu page consisting of a plurality of menu items; the second screen page is a page consisting of a plurality of tabs; the first selection control means selects sequentially the menu item along up and down direction every oscillating operation or rotating operation of the control switch part; the second selection control means selects sequentially the tab along right and left direction every pushing operation of the control switch part; and the transfer means transfers a screen page by means of pushing operation of the control switch part to the screen page related to the menu item selected by oscillating operation or rotating operation of the control switch part.

According to the present invention, an information terminal comprises a tab transfer means which transfers a screen page on which a plurality of tabs are displayed to a screen page related to the tab selected by pushing operation of the control switch part for a time longer than a predetermined time.

According to the present invention, the control switch part is capable of oscillating operation within a predetermined range and is capable of pushing operation only at the approximately center position of the predetermined range.

According to the present invention, an information terminal capable of storing at least one information and displaying a list of attribute information which discriminates the stored information on a display part comprises a first mode which displays or activates an information corresponding to the pointed attribute information pointed by pointing operation to an attribute information, a second mode adding sequentially as a candidate an information corresponding to the pointed attribute information pointed sequentially by pointing operation to an attribute information, and a mode selection means for selectively changing the first mode to the second mode or vise versa wherein the same process is executed in one lump for at least one information pointed as a candidate on the second mode by predetermined pointing operation.

According to the present invention, an information terminal capable of storing at least one information and displaying a list of the stored information on a display part comprises a control switch part capable of oscillating or rotating and pushing, a third mode which displays or activates an information selected by pushing operation of the control switch part after selecting an information on the list of the stored information by oscillating or rotating operation, and a forth mode which adds sequentially the information selected as a candidate by pushing operation of the control switch part after selecting an information on the list of the stored information by oscillating or rotating operation of the control switch part and deletes all of the added candidate information by predetermined other operation wherein the third mode and the forth mode can be selectively changed each other.

According to the present invention, an information terminal having a touch panel and capable of displaying e-mails as a list on the touch panel comprises a fifth mode which transfers the list screen page to a screen page displaying contents of the e-mail touched by touch operation to an e-mail on the list page, and a sixth mode which adds sequentially the selected e-mail as a candidate by touch operation to an e-mail on the list of the e-mails and deletes all of the added candidate e-mails by predetermined touch operation wherein the fifth mode and the sixth mode can be selectively changed each other by touch operation.

According to the present invention, an information terminal capable of displaying a list of stored e-mails received on a display part comprises a control switch part capable of oscillating or rotating and pushing, a seventh mode which selects an e-mail on the list page of the e-mails by oscillating or rotating operation of the control switch part and transfers to a screen page displaying contents of the e-mail selected by pushing operation of the control switch part, and a eighth mode which selects an e-mail on the list page of the e-mails by oscillating or rotating operation of the control switch part and after adding sequentially the selected e-mail as a candidate by pushing operation of the control switch part, deletes all of the added candidate e-mails by predetermined other operation wherein the seventh mode and the eighth mode can be selectively changed each other.

According to the present invention, a program for processing displaying information is programmed to run on an information terminal capable of storing at least one information and displaying a list of attribute information discriminating the stored information on a display part and comprises a first step which displays or activates an information corresponding to the pointed attribute information by pointing operation to an attribute information on the list page of the attribute information, a second step which adds sequentially an information corresponding to a pointed attribute information as a candidate by sequential pointing operation to an attribute information, a mode selection step which changes selectively the first mode and the second mode each other, and a processing step which executes the same step as a lump for at least one information added by the second step as a candidate.

According to the present invention, a program for processing displaying information is programmed to run on an information terminal capable of storing at least one information and displaying a list of the stored information and comprises a third step which selects an information on the list of the information by oscillating or rotating operation of a control switch part capable of oscillating or rotating and pushing and displays or activates the information selected by pushing operation of the control switch part, a forth step which selects an information on the list of the information by oscillating or rotating operation of a control switch part, adds sequentially as a candidate by pushing operation of the control switch part and delete all of the sequentially added candidate information by predetermined other operation, and a changing step which changes selectively the third step and forth step each other.

According to the present invention, an information terminal having a display control means displaying a screen page on a display part comprises a switch capable of oscillating or rotating operation and pushing operation, a horizontal scroll control means which scrolls the screen page in the horizontal direction by oscillating or rotating operation of the switch, and a vertical scroll control means which scrolls the screen page in the vertical direction by oscillating or rotating operation of the switch wherein the horizontal scroll control means and the vertical scroll control means are selectively activated each other every pushing operation of the switch.

According to the present invention, an information terminal having a display control means displaying a screen page on a display part comprises a switch capable of oscillating or rotating operation and pushing operation, a horizontal scroll control means which scrolls the screen page in the horizontal direction by oscillating or rotating operation of the switch, a vertical scroll control means which scrolls the screen page in the vertical direction by oscillating or rotating operation of the switch, a page turning control means which turn the screen page by oscillating or rotating operation of the switch, and a control changing means which activates alternatively at least two control means of the horizontal scroll control means, the vertical scroll control means and the page turning control means every pushing operation of the switch.

According to the present invention, an information terminal having a display control means displaying a screen page on a display part comprises a switch capable of oscillating or rotating operation and pushing operation, a horizontal scroll control means which scrolls the screen page in the horizontal direction by oscillating or rotating operation of the switch, and a vertical scroll control means which scrolls the screen page in the vertical direction by oscillating or rotating operation of the switch, a page turning control means which turn the screen page by oscillating or rotating operation, a second control changing means which activates alternatively at least two control means of the horizontal scroll control means, the vertical scroll control means and the page turning control means by pushing operation of the switch, and a control change restricting means which restricts a control means changeable by the second control changing means on the screen page displayed on the display part.

According to the present invention, the control change restricting means restricts in accordance with a size or a kind of the screen page.

According to the present invention, a menu screen page which displays a plurality of menu items can be displayed and a menu item is selected from a plurality of the menu items displayed on the menu screen page by oscillating or rotating operation in case of a displayed screen page is the menu screen page and a screen page is transferred to the screen page corresponding to the menu item.

According to the present invention, a cursor can be displayed on the display part, the cursor moving in the horizontal or vertical direction instead of scrolling horizontally or vertically the displayed screen page by the horizontal/vertical scroll control means.

According to the present invention, a program for processing displaying information is programmed to run on an information terminal displaying a screen page and comprises a horizontal scroll controlling step which scrolls horizontally the displayed screen page by oscillating or rotating operation of a switch capable of oscillating or rotating and pushing, a vertical scroll controlling step which scrolls vertically the displayed screen page by oscillating or rotating operation of the switch, and a changing step which activates selectively the horizontal scroll controlling step and vertical scroll controlling step every pushing operation of the switch.

According to the present invention, a program for processing displaying information is programmed to run on an information terminal displaying a screen page and comprises a horizontal scroll controlling step which scrolls horizontally the displayed screen page by oscillating or rotating operation of a switch capable of oscillating or rotating and pushing, a vertical scroll controlling step which scrolls vertically the displayed screen page by oscillating or rotating operation of the switch, a page turning control step which turn the screen page by oscillating or rotating operation of the switch, and a control changing step which activates alternatively at least two control steps of the horizontal scroll control step, the vertical scroll control step and the page turning control step every pushing operation of the switch.

According to the present invention, a program for processing displaying information is programmed to run on an information terminal displaying a screen page and comprises a horizontal scroll controlling step which scrolls horizontally the displayed screen page by oscillating or rotating operation of a switch capable of oscillating or rotating and pushing, a vertical scroll controlling step which scrolls vertically the displayed screen page by oscillating or rotating operation of the switch, a page turning control step which turn the screen page by oscillating or rotating operation of the switch, a second control changing step which activates alternatively at least two control steps of the horizontal scroll control step, the vertical scroll control step and the page turning control step every pushing operation of the switch, and a control change restricting step which restricts a control step changeable by the second control changing step on the screen page displayed on the display part.

According to the present invention, an information terminal comprises a display controlling means capable of displaying at least one part of a plurality of items on a display part, the display controlling means further comprising an item selecting means which selects an item from a plurality of items related to a plurality of groups of related information each of which consists of a plurality of related information linked to each other, an item determining means which determines the selected item, and an instructing means which instructs to display a related information linked to a plurality of the groups of related information, wherein when an item is determined by the item selecting means and the item determining means, at least one part of related information of the related information groups related to the determined item is displayed on the display part and another related information is displayed instead of at least one part of related information on display.

Thus, another related information is displayed instead of at least one part of the related information on display by an item selecting means which selects an item from a plurality of items related to a plurality of groups of related information each of which consists of a plurality of related information linked to each other, an item determining means which determines the selected item, and an instructing means which instructs to display a related information linked to a plurality of the groups of related information so that a linked information can be selected with simple operation, which leads to enhancing operationality.

According to the present invention, an information terminal has a switch part capable of oscillating or rotating and pushing operation; the item selecting means selects an item from a plurality of items by oscillating or rotating operation of the switch part; the item determining means determines the selected item by pushing operation of the switch part; and the instructing means instructs to display the related information linked to the related group of information by pushing operation of the switch part at least after determining operation of the item by the switch part. Thus, a linked information can be selected with simple operation.

According to the present invention, an information terminal comprises a switch part capable of oscillating or rotating and pushing operation, a display part capable of displaying various types of information by oscillating or rotating and pushing operation of the switch part, and a related information group display controlling means which displays a group of related information consisting of a plurality of related information linked to each other and the related information group, the related information group display controlling means displaying sequentially on the display part a plurality of related information linked to the related information every pushing operation, wherein a detailed information linked to the linked information can be displayed on a screen page. Thus, the detailed information is consulted or referred with simple operation.

According to the present invention, an information terminal comprises an item displaying area which displays a plurality of items, a related information displaying area which displays a related information of a group of a plurality of related information related to the plurality of items, an item selecting means which selects an item from a plurality of the items by putting a cursor thereon, an item determining means which determines the selected item, an instructing means which instructs to display a related information linked to the related information group, and a display controlling means which, in case an item of the item displaying area is determined by the item selecting means and the item determining means, displays at least one part of the related information group related to the determined item on the related information displaying area and, transferring a cursor to the related information displaying area, displays another linked related information instead of at least one related information on display on the related information displaying area with the instructing means. Thus, a detailed information further linked to a linked information can be displayed on a screen page by pushing operation of the switch part after selecting a linked information so that a detailed information can be consulted and referred by a simple operation.

Further, said item is displayed as an array in a first direction on a screen page of the display part and said related information is displayed as an array in a second direction which is approximately orthogonal to the first direction on a screen page of the display part. A group of the related information are information of an address book consisting of a plurality of personal data information. The linked related information are personal data information such as names, telephone numbers and addresses.

According to the present invention, an information terminal comprises a switch part capable of oscillating or rotating and pushing operation, a display area of tabs of the 50-character kana syllabary which displays tabs of the 50-character kana syllabary, a display area of personal information which displays linked personal data for a plurality of persons consisting of at least personal names, telephone numbers and addresses, and a means for selecting tabs of the 50-character kana syllabary which selects the tab of a kana character from the tabs of the 50-character kana syllabary by oscillating or rotating operation of the switch part, wherein at least personal name data of personal names which begin with the kana letter selected by pushing operation of the switch part are displayed on the display area of personal information and other linked personal data is displayed on the display area of personal information every pushing operation of the switch part.

According to the present invention, a program for processing displaying information is programmed to run for a display controlling means and comprises the steps of, displaying at least a part of a plurality of items on a display part, selecting an item from a plurality of the items, displaying at least one part of linked related information of a group of a plurality of related information consisting of a plurality of linked related information linked to the selected item each other, and displaying other linked related information instead of the at least one part of the related information on display by instruction to display a linked related information of a group of the related information.

According to the present invention, a program for processing displaying information is programmed to run for a display controlling means and comprises the steps of, displaying on a display part at least one related information of a group of related information consisting of a plurality of information linked to each other by operation of a switch part capable of oscillating or rotating and pushing operation, and displaying sequentially on the display part a plurality of related information linked to a group of the related information.

According to the present invention, a program for processing displaying information is programmed to run for a display controlling means and comprises the steps of, selecting an item on an item displaying area of a display part displaying a plurality of items by oscillating or rotating operation of a switch part capable of oscillating or rotating and pushing operation, displaying a part of linked related information of a group of related information related to the selected item among a plurality of related information groups on the related information displaying area by pushing operation of the switch part, and displaying other linked related information on the related information displaying area by pushing operation of the switch part instead of at least one related information on display by the former step.

According to the present invention, a program for processing displaying information is programmed to run for a display controlling means and comprises the steps of, selecting the tab of a kana character from tabs of the 50-character kana syllabary displayed on a tabs of the 50-character kana syllabary displaying area of a display part by oscillating or rotating operation of the switch part, displaying at least personal name data of personal data of personal names which begin with the selected kana character on a personal information area of the display part by pushing operation of the switch part, and displaying other linked personal information on the personal displaying area every pushing operation.

Thus, using above-mentioned program, a linked information can be selected and a detailed information is consulted and referred only by operating the switch part capable of oscillating or rotating and pushing so that operationality is enhanced.

### BRIEF DESCRIPTION OF THE DRAWINGS

FIG. 1 is a perspective view showing an external appearance of one embodiment of a portable information terminal according to the present invention.

FIG. 2 is a block diagram showing one example of a control system used for the portable information terminal shown in FIG. 1.

FIG. 3 is a schematic drawing showing one example t of a screen page of a setting tool.

FIG. 4 is a schematic drawing showing one example of a tab disposition in a screen page of a setting tool shown in FIG. 3.

FIG. 5 is a schematic drawing showing one example of a tab transition (transfer) in case a hidden tab exists in the state shown in FIG. 4.

FIG. 6 is a schematic drawing showing one example of a tab transition (transfer) in case a hidden tab does not exist in the state shown in FIG. 4.

FIG. 7 is a schematic drawing illustrating selection of a tab by shift button operation.

FIG. 8 is a schematic drawing showing one example of a launcher screen page displayed on a portable information terminal shown in FIG. 1.

FIG. 9 is a schematic drawing showing one example of a tab setting screen page displayed on a portable information terminal shown in FIG. 1.

FIG. 10 is a schematic drawing showing another example of a screen page of a setting tool displayed on a portable information terminal shown in FIG. 1.

FIG. 11 is a schematic drawing showing one example of a list page of newly arrived mails displayed on a portable information terminal shown in FIG. 1.

FIG. 12 is a schematic drawing showing one example of a list page of newly arrived mails in delete mode (a list page of delete mode of newly-arrived mails) transferred from the list page of newly arrived mails shown in FIG. 11.

FIG. 13 is a schematic drawing showing one example of a screen page of a file content displayed on a portable information terminal shown in FIG. 1.

FIG. 14 is a flow chart illustrating scroll control and page turning control used in a portable information terminal shown in FIG. 1.

FIG. 15 is a schematic drawing showing one example of a screen page of an address list displayed on a portable information terminal shown in FIG. 1. as a state when “ALL” is selected.

FIG. 16 is a schematic drawing showing one example of a screen page of an address list displayed on a portable information terminal shown in FIG. 1 as a state when the first line of the 50-character kana syllabary is selected.

FIG. 17 is a flow chart illustrating selection of a 50-character kana tab and an address, and consultation and reference of personal data by operation of a side controller on a screen page of an address list.

FIG. 18 is a schematic drawing showing a movement of a cursor by pushing operation of a side controller when the first line of the 50-character kana syllabary is selected on a screen page of an address list.

FIG. 19 is a schematic drawing showing one example of a screen page of group selection displayed on a portable information terminal shown in FIG. 1.

FIG. 20 is a schematic drawing showing one example of a screen page of personal information displayed on a portable information terminal shown in FIG. 1.

### DETAILED DESCRIPTION OF THE PREFERRED EMBODIMENTS

The invention will now be described in detail by way of example with reference to the accompanying drawings. It should be understood, however, that the description herein of specific embodiments such as to the dimensions, the kinds of material, the configurations and the relative disposals of the elemental parts and the like is not intended to limit the invention to the particular forms disclosed but the intention is to disclose for the sake of example unless otherwise specifically described.

### First Embodiment

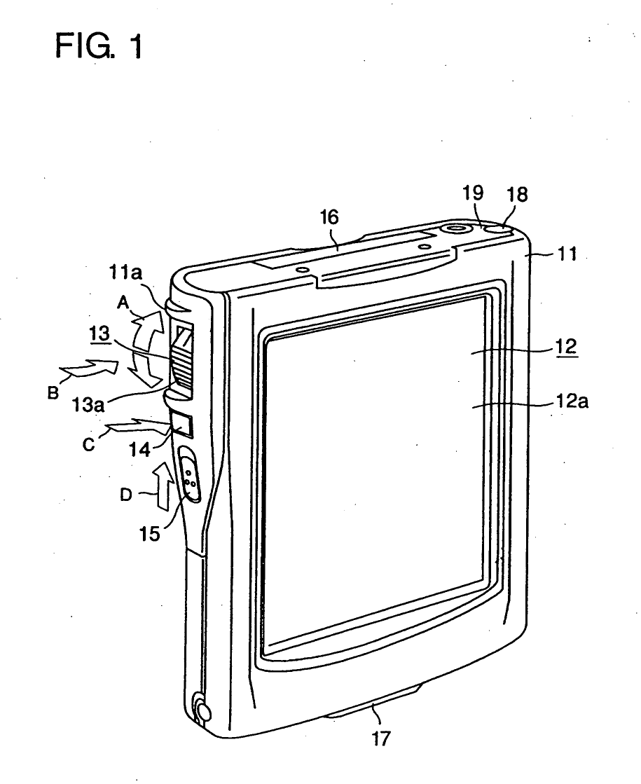

Referring to FIG. 1, a portable information terminal (PDA) is as large as a user can hold in his or her palm of the hand. A liquid crystal panel 12 having a touch panel 12a is provided throughout nearly all of the front face of a case 11 (The touch panel 12a is disposed, for example, on the surface of the liquid crystal panel 12.). Further, as described later, a control switch (hereinafter referred to as a side controller) 13, an escape switch 14, a power source on-off switch (hereinafter referred to as a power switch) 15, an insert slot 16 into which an external memory medium such as a memory card, a communication device such as a communication card or an external device such as an external hard disc is inserted, an external connection terminal 17 used for communication of a variety of data with a personal computer or power charging, and a storage part 19 for storing a touch pen (a stylus pen) 18 are provided on the case 11.

As shown in FIG. 1, the side controller 13, the escape switch 14 and the power switch 15 are disposed from top to down in this sequence on the side face of the case 11. The side controller is disposed in the area where the thumb of the user's left hand touches the controller 13 when the case is held with the user's left hand so that the liquid crystal panel 12 faces in front of the user.

A protruded part 11a extending toward outer direction is formed at the upper part of the side controller 13. A part of the side controller 13 is exposed from the side face of the case 11. The side controller 13 is supported by an axis (unshown) extending from the anterior (front) to the back face of the case 11 so as to be capable of oscillating or rotating in the direction shown by a solid arrow A (up and down direction) in the figure within a predetermined range and to be capable of pushing in the direction orthogonal to the axis (in the direction from the lateral side to the inside of the figure) (in the direction of the solid arrow B). The range of rotation (oscillation) is restricted within the range capable of rotating (oscillating) operation by nearly one upward push or downward push with a thumb of the left hand. Wave formed protrusions 13a are formed on the exposed surface of the side controller 13.

The side controller 13 is rotated (oscillated) or pushed, for example, by a thumb of the left hand. The thumb of the left hand touches the protrusion 13a in this regard. The side controller 13 stays at a predetermined position (hereinafter referred to as a standard position) under the condition of non-operation. When it is pushed upward from the standard position with a thumb of the left hand, the side controller 13 is rotated (oscillated) by predetermined rotating amount and is not rotated (oscillated) more. When the thumb is released from the side controller 13 (i.e., a force to rotate (oscillate) is removed), the side controller 13 returns to the standard position (approximately center position of the rotating range) by itself. Identically, when it is pushed downward from the standard position with a thumb of the left hand, the side controller 13 is rotated (oscillated) by predetermined rotating amount and is not rotated (oscillated) more. When the thumb is released from the side controller 13, the side controller 13 returns to the standard position by itself. It is preferable that pushing operation can be carried out only at the standard position. That is because wrong operation of pushing needs to be prevented in case of rotating (oscillating) operation. Since the side controller 13 is operated by the thumb of the left hand which holds the PDA itself, movement of the thumb is limited so that complicated operation is difficult. Therefore, as oscillating operation is easy to operate than rotating operation which needs more complicated operation, the side controller 13 is preferably operated by oscillating operation.

The side controller 13 sends an operating signal corresponding to the rotating (oscillating) or pushing operation. A various processes are executed according to the signal as stated later.

The escape switch 14 is disposed at the lower part of the side controller 13; the power switch 15 is disposed at the lower part of the escape switch 14; a plurality of dot like protrusions are formed on the surface of the power switch. In addition, these side controller 13, escape switch 14, power switch 15 are disposed at the position capable of operating, for example, by a thumb of the left hand.

In the example shown in the figure, the escape switch 14 is pushed (solid arrow C) so as to send an escape signal(ESC) and, as described later, execute an escape operation. The power switch 15 is operated by sliding operation(solid arrow D). When the power switch 15 is slid upward, as shown in the figure, power is on and the power switch 15 returns to the initial position and again when the power switch is slid upward at the state of power on, power is off and the power switch 15 returns to the initial position.

With the external connection terminal 17, the PDA shown in the figure can be connected to a charging device (so called a cradle device) having a communication function so as to communicate data with personal computers and battery can be charged through the external connection terminal 17. The liquid crystal panel 12 is, for example, a color liquid crystal display provided with a backlight if necessary. The touch panel 12a has touch sensors, which detect touch positions and touch lines when touched (tapped) with the touch pen 18.

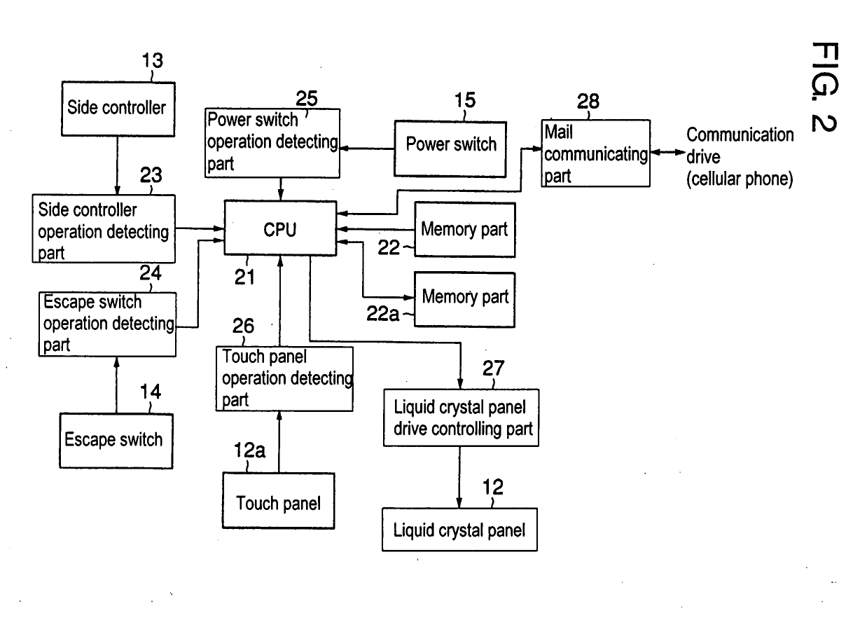

Referring to FIG. 2, a PDA has an central processing unit (CPU) 21 which controls the entire PDA in accordance with control programs stored in a memory part 22 such as ROM and executes a variety of processes, which is described later, in accordance with application programs. Application programs are downloaded from an external memory medium inserted in the insert slot 16 or from outside by communication as the case may be. A memory part 22a capable of writing or reading, which consists of such as RAMs is connected to the CPU 21. (contents stored to the memory part 22a do not disappear even if power is off.)

As shown in the figure, the CPU 21 is connected to the side controller 13 through a side controller operation detecting part 23 and further to the escape switch 14 through an escape switch operation detecting part 24. Further, the CPU 21 is connected to the power switch 15 through a power switch operation detecting part 25. The CPU 21 is also connected to the touch panel 12a through a touch panel operation detecting part 26 and to the liquid crystal panel 12 through a liquid crystal panel driving part 27.

The PDA has a mail communicating part (a mail communicating function) 28 (it may be provided to a communication card inserted in the insert slot 16), which is connected to the CPU 21. The mail communication part 28 sends or receives mails through communication devices such as cellular phones or communication cards. Every time a mail is received or sent, the CPU 21 stores the received or sent mail in the memory part 22a. The stored received or sent mails can be read out from the memory part 22a to consult.

In the state that power of the PDA is off, when the power switch 15 is slid upward, a power switch operation detecting part 25 detects the sliding operation to send a power switch operating signal to the CPU 21. Corresponding to the power switch operating signal, the CPU 21 activates the PDA to the state of power on. When power is on, CPU 21 displays an initial screen page (a menu screen page, hereinafter referred to as a launcher screen page), which is one of application programs on the liquid crystal panel 12 by controlling to drive a liquid crystal panel drive controlling part 27.

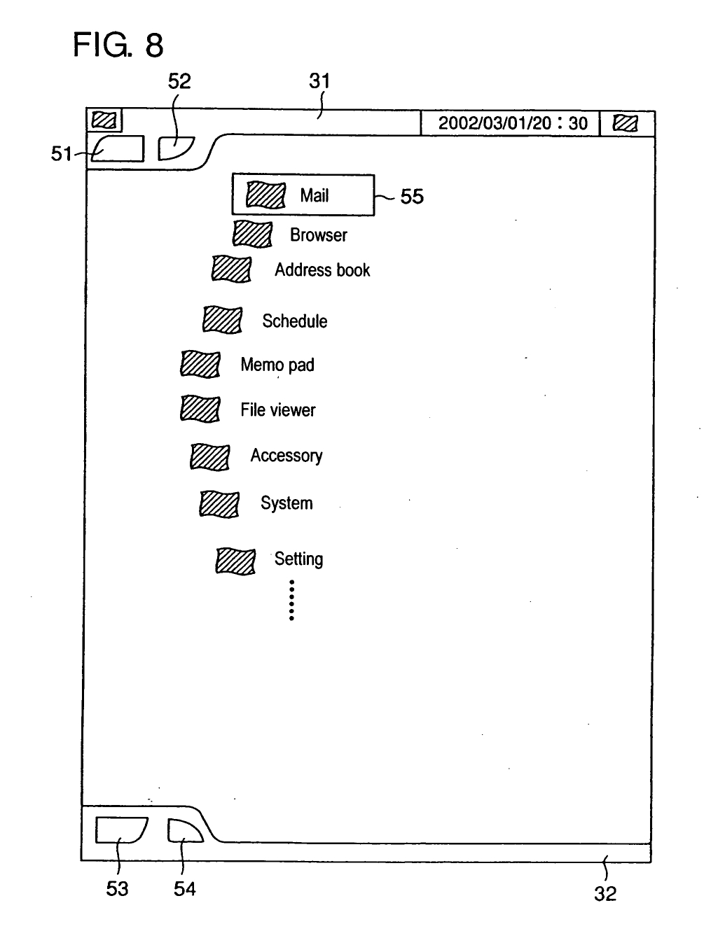

As shown in FIG. 8, menu items (selection items) such as mail, browser, address book, schedule, memo pad, file viewer, accessory, system and setting are displayed together with icons. That is to say, an application program (an application soft) concerning these menu items is stored in the memory part 22. A task bar 32 is displayed on the lower section of the launcher screen page and a title bar 31 is displayed on the upper section of the launcher screen page. Further, a scroll button (an upper scroll button) 51 and a screen page color changing button (an upper screen page color changing button) 52 are displayed on the upper-left section of the launcher screen page and a scroll button (a lower scroll button) 53 and a screen page color changing button (a lower screen page color changing button) 54 are displayed on the lower-left section of the launcher screen page.

As the cursor 55 cannot be scrolled further upper section when the cursor 55 (focus) is positioned to the most upper menu item on the screen page, the upper scroll button 51 is not displayed on the launcher screen page. Likewise, the lower scroll button 53 is not displayed on the launcher screen page when the cursor is positioned to the lowest menu item on the screen page (, which is not shown in FIG. 8.).

If the upper scroll button 51 is touched (tapped) with the touch pen 18, a touch panel operation detecting part 26 detects the tap operation for CPU 21 to move the cursor 55 to the one upper line on the screen page. That is, one touch of the upper scroll button 51 makes the cursor 55 transfer to one upper line of the menu item presently positioned.

Likewise, if the lower scroll button 53 is touched (tapped) once with the touch pen 18, the cursor 55 is transferred to one lower line of the menu item presently positioned. Further, if the upper or lower screen page color changing button 52 or 54 is tapped, a screen page color of the launcher screen page is changed every tap operation so that a screen page color of the liquid crystal panel 12 can be varied. If one of menu items is touched with the touch pen 18, an application program corresponding to the menu item is activated to display the screen page concerning the menu item.

Meanwhile, when the side controller 13 is rotated (oscillated) upwardly from the standard position, a side controller operation detecting part 23 detects the upward operation to send an upward operation signal to the CPU 21. The CPU 21 moves the cursor 55 to the upper line on the launcher screen page by this signal.

When the side controller 13 is rotated (oscillated) downwardly from the standard position, a side controller operation detecting part 23 detects the downward operation to send an downward operation signal to the CPU 21.

The CPU 21 moves the cursor 55 to the lower line on the launcher screen page by this signal. When the side controller 13 is pushed after the cursor is positioned to one of the menu items, the side controller operation detecting part 23 detects the pushing operation to send a pushing operation signal to the CPU 21. The CPU 21 activates an application program corresponding to the menu item on which the cursor 55 resides to display an operating screen page concerning the menu item by this signal. That is, on a launcher screen page on which menu items are displayed (so called a menu screen page), an application program corresponding to the menu item selected by rotating (oscillating) operation of the side controller 13 is activated by pushing operation of the side controller 13 so as to transfer the launcher screen page to the other screen page concerning to the menu item.

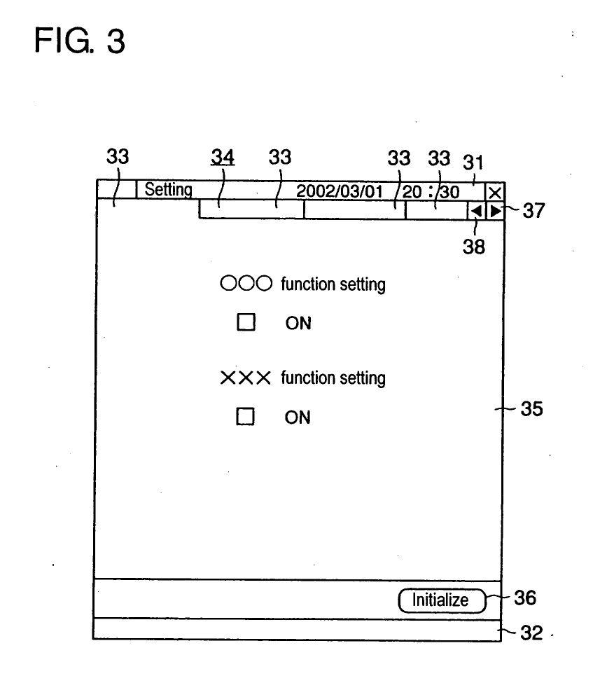

When setting is selected and activated by tap operation or side controller operation on the launcher screen page, a setting top page which is not shown in the figure is displayed. The setting top page has, for example, a setting tool and a communication setting columns. CPU 21 displays a setting tool page shown in FIG. 3 on the liquid crystal panel 12 on selecting and activating the setting tool by tap operation or side controller operation.

As shown in FIG. 3, a title bar 31 and task bar 32 are displayed on the setting tool page and a plurality of tabs 33 of items are arrayed along the predetermined direction (the right and left direction in the figure). These tabs 33 define a tab column 34. Only a part of tabs 33 (4 tabs are shown in FIG. 3.) appear on the setting tool page and other tabs are hidden to the right side of the page. That is, a number of tabs which appear on the page are predetermined so that tabs more than the predetermined number are hidden.

A setting window part 35 concerning the tab selected by the way described later is defined under the tab column 34. Further, An initializing button 36 is displayed under the setting window part 35. A shift button 37 and 38 are displayed on the right side of the tab column 34 (hereinafter the shift button 37 is referred to as a right shift button 37 and the shift button 38 is referred to as a left shift button 38). As shown in FIG. 3, on a screen page of the selected tab (an activated tab), for example, ON/OFF of a setting function of ∘∘∘ and ON/OFF of a setting function of xxx can be set as a setting widow part 35 concerning the selected tab.

In FIG. 3, when a tab is selected, a cursor is positioned to the selected tab 33 on the screen page on display. In this state, when the side controller 13 is downwardly rotated (oscillated), the cursor moves to a square mark of “on” position of a function setting of ∘∘∘. And then, if the side controller 13 is pushed, the square mark of “on” position changes to a solid square mark and the function of the ∘∘∘ is set. Further subsequently, if the side controller is again downwardly rotated (oscillated), then the cursor moves to a square mark of “on” position of a function setting of xxx. Likewise, a function of xxx is set by pushing operation of the side controller.

In this state (a state of the cursor positioned to a square mark of ‘on’), when the side controller 13 is pushed sustainedly for a time longer than a predetermined time, the screen page is transferred to a hierarchically lower setting page (a position of the tab doesn't vary). When the cursor is returned to the tab 33 by upward rotating (oscillating) operation of the side controller 13, selecting of the tab screen pages (changing of tab 33 in the right direction) becomes possible by pushing operation of the side controller 13.

Again referring to FIG. 3, when one of the tabs 33 displayed on the tab column 34 is tapped, the CPU 21 selects the tab tapped by tap operation (hereinafter referred to as a selected tab) and displays an item content (a set screen page) corresponding to the selected tab on the setting window part 35 by having access to the memory part 22a. After that, when a tab 33 which is not currently selected (hereinafter referred to as a non-selected tab) is tapped, the CPU 21 displays an item content (a set screen page) corresponding to the selected tab on the setting window part 35 by recognizing the taped non-selected tab 33 as a selected tab 33.

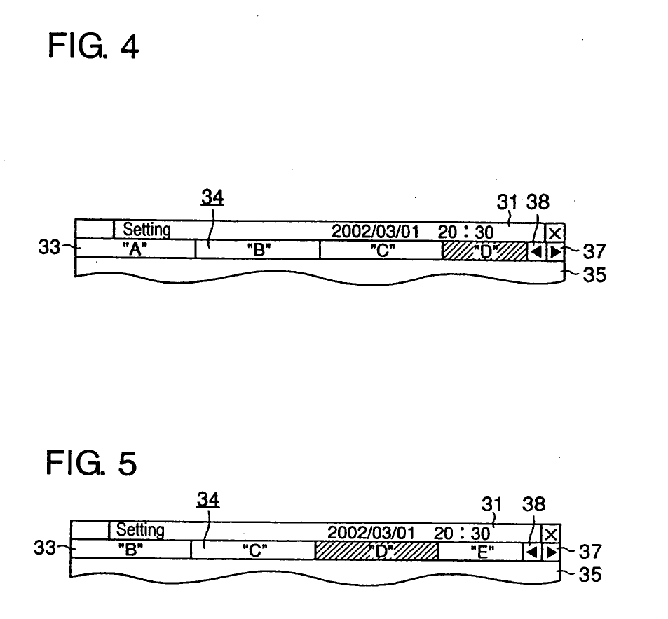

As described above, only one part of tab 33 appears on the page and other tabs are hidden. In FIG. 4, though, when a tab “D” positioned at the rightmost is tapped, the tab “D” is selected and a setting screen page is displayed corresponding to the tab “D”, all of a display area of the tab “D” is displayed. CPU 21 transfers the tab “D” to left by one tab (that is, the position of a tab “C”). (See FIG. 5) As shown in FIG. 5, CPU 21 shifts tab “D”-“B” sequentially leftward to the position of the tab “C”, “B” and “A” shown in FIG. 4. The tab “E” is positioned at the position of the tab “D” and the tab “A” is hidden.

In addition, in case the tab “D” is the last tab, namely only the tab “A”-“D” are displayed, when the tab “D” is tapped at the state shown in FIG. 4, the CPU 21 shifts the tabs “D”-“B” sequentially to position the tab “D”, “C” and “B” to the position of the tab “C”, “B” and “A”. The position of the tab “D” becomes vacant and the tab “A” is hidden.

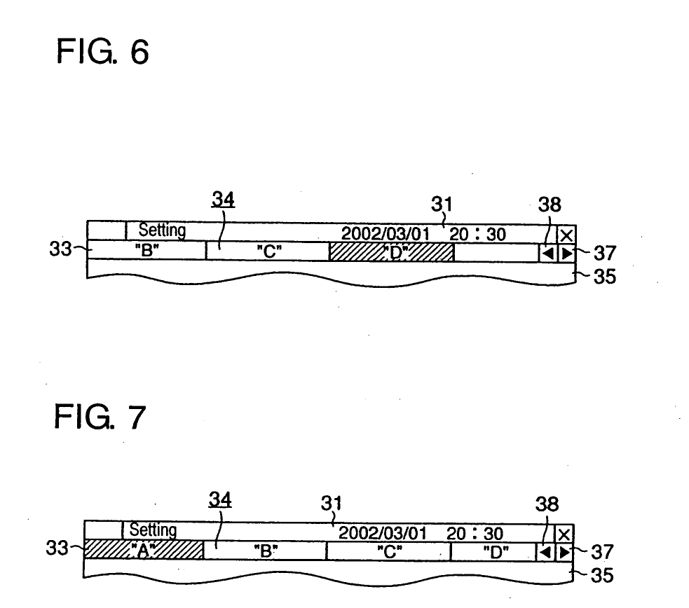

Meanwhile, in the setting tool screen page shown in FIG. 3, the selecting tab 33 shifts sequentially in the right direction of FIG. 3 by tapping operation of the right shift button 37. On the other hand, the selecting tab 33 shifts sequentially in the left direction of FIG. 3 by tapping operation of the left shift button 38. And the CPU 21 executes right shift operation so that the tab A of the top tab is made as a selected tab by tapping operation of the right shift button 37 in the state the selected tab is tab “D” (the last tab) as shown in FIG. 6 (see FIG. 7).

Further, the CPU 21 execute left shift operation so that the tab D of the last tab is made as a selected tab by tapping operation of the left shift button 38 in the state the selected tab is tab “A” (the top tab) (see FIG. 6).

Thus, tabs 33 in hidden state appears sequentially on a screen page of a setting tool in accordance with tap operation of the right or left shift button 37 or 38 and currently appeared tabs on the setting tool screen page disappear sequentially.

A set content corresponding to the currently selected tab is initialized by tapping of an initializing button 36(for example, to a state of shipment).

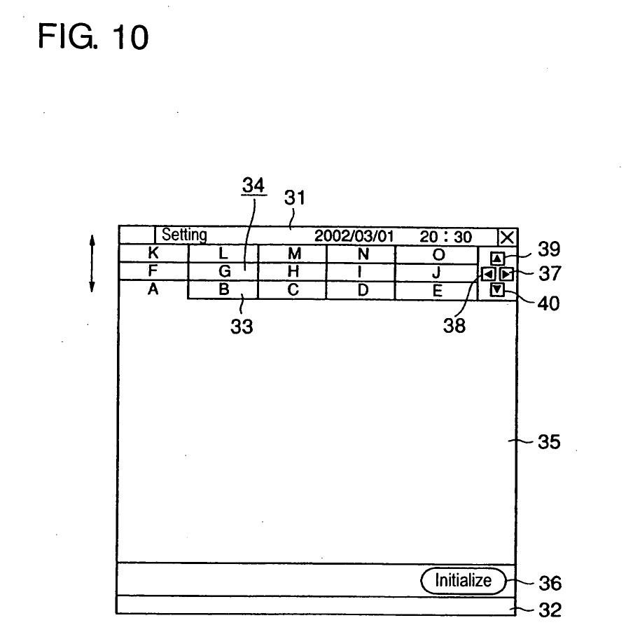

Since the above-described tab selecting operation by tap operation requires both hands, the PDA cannot be operated when one hand is unavailable. With this regard, CPU 21 can activate tab-selecting operation by operating the side controller 13 according to this embodiment. When the setting tool screen page shown in FIG. 3 is selected, CPU 21 doesn't accept rotating (oscillating) operation of the side controller 13 but accepts only pushing operation. In a setting tool screen page shown in FIG. 10 described later, CPU 21 accepts rotating (oscillating) operation to activate a tab selection.

In FIG. 3, in case the setting tool screen page is displayed, CPU 21 makes the right adjacent tab to the currently selected tab a selected tab, and makes the currently selected tab a non-selected tab by pushing operation of the side controller 13. The CPU 21 shifts a selected tab to the right side every time the side controller is pushed. That is, the CPU 21 performs a right direction shift to sequentially change a selected tab every time the side controller is pushed. In other words, in a screen page displaying a plurality of tabs such as a setting tool screen page, different from the aforementioned launcher screen page (a so-called menu screen page which displays a plurality of menu items), a tab is sequentially selected (changed) by pushing operation of the side controller 13.

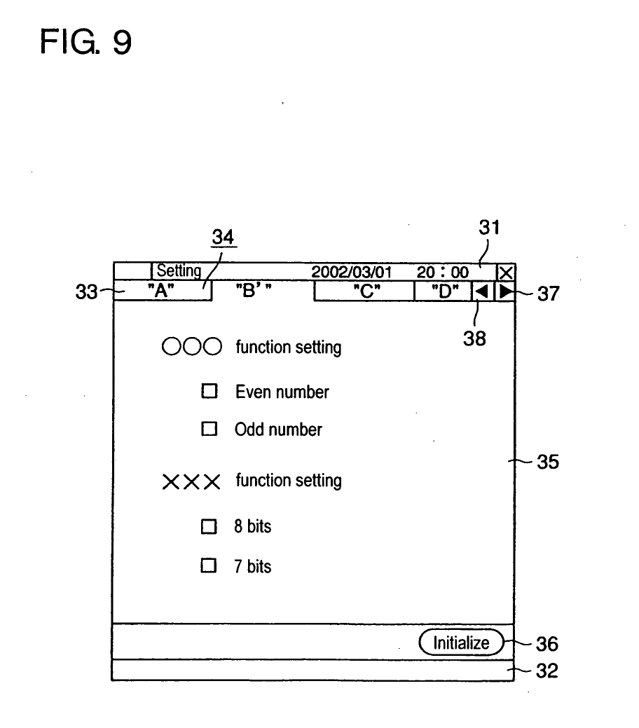

In case a last tab is a selected tab, CPU 21 performs a right direction shift to make a front tab a selected tab by pushing the side controller 13. Further, CPU 21 returns to a set top screen page. In a set top screen page by pushing the escape switch, CPU 21 returns to a launcher screen page. When the side controller is pushed for a time longer than a predetermined time after e.g. a tab B is selected, a screen page transfers to a detailed setting screen page B′ concerning the tab B shown in FIG. 9. The detailed setting screen page B′ is a detailed setting screen page related to a setting content of the tab B and makes a setting possible, a setting hierarchically lower than the setting screen page of the tab B. When a screen page is transferred to this screen page, as described before showing FIG. 3, a setting tab among a variety of setting tabs, such as a tab of “even number” of setting of ∘∘∘ as shown in FIG. 9, is arbitrarily selected by rotating (oscillating) operation of the side controller 13 and the aforementioned selected tab, e.g. the above tab of “even number”, is determined by pushing operation of the side controller 13. After finishing a variety of setting on this page, the screen page returns to a setting tool page shown in FIG. 3 by prolonged pushing operation of the side controller 13 or operation of the escape switch 14. Further here, a screen page maybe transferred to a further hierarchically lower layer of a detailed setting screen page by prolonged pushing operation of the side controller 13.

Thus, since a selected tab is sequentially changed by right shifting every time the side controller 13 is pushed, a tab is selected by extremely simple operation so that operationality is enhanced particularly under the mobile circumstance. That is to say, a plurality of tabs are arrayed along the predetermined direction and a focus is moved in the predetermined direction every time the side controller 13 is pushed to activate a tab as a selected tab. In this occasion, if there are hidden tabs, an appeared tab on the screen page is changed by pushing operation of the side controller 13. Further, a screen page can be transferred to a detailed setting page concerning the selected (active) tab by pushing operation of the side controller 13.

Referring to FIG. 10, CPU 21 may display a setting tool screen page shown in FIG. 10 by selecting and activating setting tool on a setting top page, which is not shown in the figure. Tab 33 is displayed two-dimensionally such as “A”-“O” as tabs in the figure shown. Right and left shift buttons 38 and 37 and an up and down shift buttons 39 and 40 are defined on the setting tool screen page. A selecting tab is changed in the right and left direction by tap operation of the right and left shift button 38 and 37 as explained in FIG. 3. Likewise, a selecting tab is changed in the up and down direction by tap operation of the up and down shift button 39 and 40. Meanwhile, a selecting tab is changed corresponding to the direction of oscillating direction by rotating (oscillating) operation of side controller 13. (That is, a tab is changed to the direction indicated by a solid both sides arrow line of FIG. 10.) For example, when the tab “A” is selected, a tab is changed to “A”, “F” and “K” in this sequence by rotating (oscillating) operation of the side controller 13. Further, every time the side controller 13 is pushed, a selected tab is changed to “A”, “B”, . . . , “E”, “F”, “G”, . . . “O”, “A”, . . . in this sequence.

Though tab selection on the selecting tool screen page was explained above, function items which indicate applications, various icons or menu items can also be arrayed two-dimensionally. An application may be executed by prolonged pushing operation of the side controller 13. It is also possible that after selecting only by rotating (oscillating) operation of the side controller 13 with regard to a variety of items, the selected item is executed by pushing operation of the side controller 13.

Further, though tab selection on the setting tool screen page is explained above, if items such as tabs are appear on the screen page, selecting operation can be performed on other displayed screen pages (operating screen pages) other than the setting tool.

As stated above, since, every time the control switch part which is supported rotatably within the predetermined range and pushably, is pushed, a selecting item is sequentially changed so as to select a selecting item from a plurality of items to activate, a selecting item is selected from a plurality of items with a simple operation and operationality is effectively enhanced.

Since a plurality of items are arrayed in the predetermined direction and a selecting item is selected to activate along the predetermined direction every time the control switch part is pushed, a presently selected item is easily apparent and operationality is effectively enhanced.

Further, since, when a plurality of items are a plurality of tabs arrayed in the predetermine direction and a part of a plurality of tabs are displayed on a screen page, a tab is sequentially selected to activate in the predetermined direction every pushing operation of the control switch and a tab appearing on the displayed screen page is changed, operationality is effectively enhanced.

In addition, since the control switch part is supported by an axis extending in a predetermined direction so as to be capable of oscillating around the axis from a predetermined standard position within a predetermined range and so as to be capable of pushing at a standard position in the direction orthogonal to the oscillating axis, the control switch part can be easily operated by a single hand so that operationality is effectively enhanced.

Further, since a display part is disposed on the most part of the front face of a case of an information terminal and control switch part is disposed at the side face of the case of the information terminal with a predetermined axis in the direction from the front to the back face of the case and with a pushing direction orthogonal to the side face, the display part, the control switch part and the arraying direction of function items are convenient to a user so that operationality is effectively enhanced.

### Second Embodiment

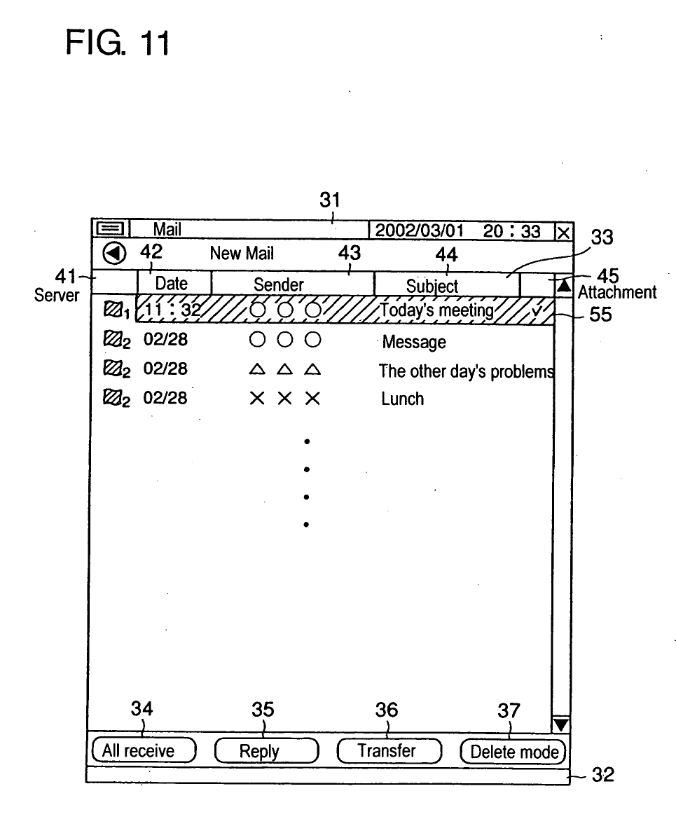

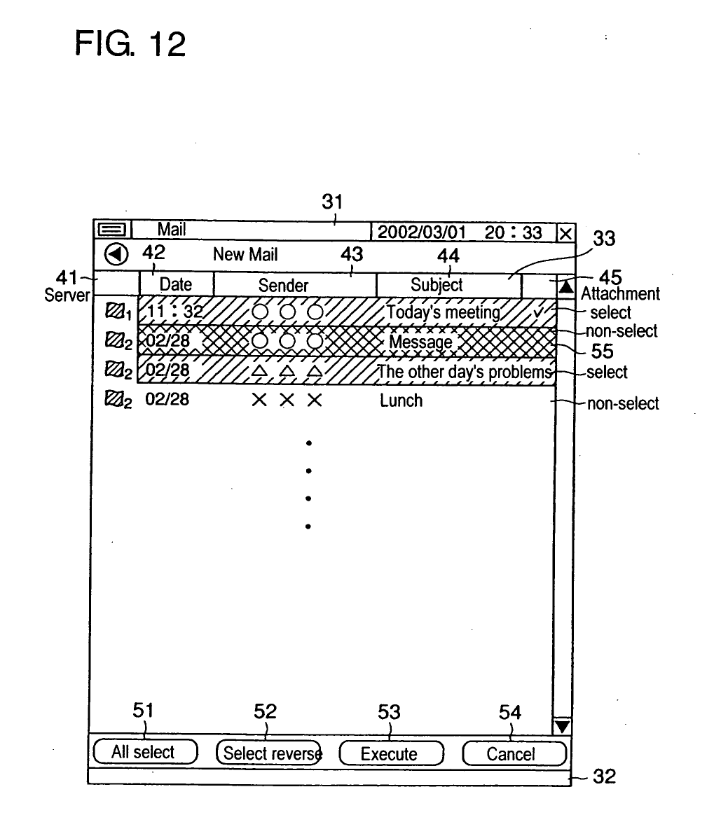

In a second embodiment of the present invention described below, constitutions of apparatuses and restricted conditions described by and shown in FIGS. 1, 2 and 8 in the first embodiment are the same as in the second embodiment unless otherwise specifically described. The explanation done in the first embodiment is to be replaced in the second embodiment as far as FIGS. 1, 2 and 8 are concerned, though the explanation in the second embodiment for these figures is omitted. It follows therefore that the second embodiment will be described by adding and referring to FIGS. 11 and 12.

A mail top screen page is displayed when “mail” is selected and activated on a launcher screen page shown in FIG. 8 of a portable information terminal shown in FIG. 1 by tap operation on the launcher screen page or by side controller operation. The mail top screen page has “list of newly arrived mails”, “composing mail”, “list of mails”, “draft” and “setting of server environment”. If “list of newly arrived mails” is selected and activated, a CPU 21 displays a screen page of a list of newly arrived mails shown in FIG. 11 on a liquid crystal panel 12. Newly arrived mails and unread mails are displayed on the screen page of a list of newly arrived mails.

Referring to FIG. 11, a title bar 31 and a task bar 32 are displayed on the screen page of a list of newly arrived mails; an attribute information displaying column 33 is further defined thereon, in which an attribute information of every newly arrived mail is displayed. A plurality of function buttons are displayed in the down part of the screen page of a list of newly arrived mails. For example shown in FIG. 11, an all-receive button 34, a reply button 35, a transfer button and a delete mode button 37 are displayed. The delete mode button 37 here in functions as a selection mode button described later. An application name and date and time are displayed in the title bar 31; icons defining a variety of tasks which are not shown are displayed in the task bar 32 displayed in the dawn part of the function buttons.

In FIG. 11, when an all-receive button 34 is tapped, the CPU 21 receives mails from all servers set in PDA. When a reply button 35 is tapped, the CPU 21 displays on the liquid crystal panel a reply mail writing screen page for replying to a received mail on which a cursor 55 is positioned. When a delete mode button 37 is tapped, the CPU 21 transfers to a delete mode described later. As for attribute information of every newly arrived mail, there are a server icon 41, a received date and time 42, a sender's name 43, a subject name 44 and an attached file indication 45 which indicates an existence of an attached file. When a region of one of attribute information of a newly arrived mail is arbitrarily tapped such as a server icon 41, a received date and time 42, a sender's name 43, a subject name 44 and an attached file indication 45 in FIG. 11, the CPU 21 automatically transfers to a screen page which displays in details a content of the newly arrived mail corresponding to the attribute information. That is, if a newly arrived mail on the screen page of a list of newly arrived mails is tapped, the newly arrived mail can be opened. An action such as opening a newly arrive mail can also be done by side controller 13. In the screen page of a list of newly arrived mails, a cursor 55 moves up and down in the page in accordance with rotating or oscillating operation of the side controller 13. And, when a user pushes the side controller 13 after positioning a cursor to an attribute information corresponding to the newly arrived mail which he or she needs to open to read the content thereof. In other words, CPU 21 can perform an action to open a newly arrived mail on which a cursor is positioned by rotating or oscillating and pushing operation of the side controller 13.

Tapping the delete mode button 37 here, CPU 21 transfers to a delete mode to display the screen page of a list of newly arrived mails in delete mode shown in FIG. 12. An all subjects selection button 51, a selecting reverse button 52, an execute button 53, and a cancel button are displayed as function buttons as shown in FIG. 12. In the screen page of a list of newly arrived mails in delete mode, when tapping one of displayed regions corresponding to an attribute information such as server icon, date and time, sender, subject name, or attachment, CPU 21 selects the tapped newly arrived mail corresponding to the attribute information as a delete target. At this conjuncture, a cursor 55 is positioned to a tapped newly arrived mail and focused. In this focused state, back ground color of the selected newly arrived mail is black and letter color of the same is cyan, for example. After that, when an attribute information corresponding to another newly arrive mail is tapped, CPU 21 aims at a newly arrived mail corresponding to the attribute information. In this occasion, the cursor 55 moves to an attribute information corresponding to the newly arrived mail to focus now the newly arrived mail at this time and the selected newly arrived mail aimed to delete, which has focused and tapped formerly is colored with blue back ground and with yellow letter.

In this manner, when a attribute information is tapped in a delete mode, a newly arrived mail corresponding to the attribute information is selected as a delete target. That is, in here, when an attribute information is tapped, a selecting signal indicating to select a newly arrived mail corresponding to the tapped attribute information is generated to be transmitted to the CPU 21. The CPU 21 aims the relevant newly arrived mail to delete in accordance with the selecting signal.

Selection of a newly arrived mail aimed to delete as described above can be performed by the side controller 13 also. In the screen page of a list of newly arrived mails in delete mode shown in FIG. 12, a cursor 55 moves up and down in the figure on the screen page of the list in delete mode in response to rotating or oscillating operation of the side controller 13. When, after a cursor is positioned to an attribute information concerning a newly arrived mail which a user aims to delete, the side controller is pushed, a newly arrived mail corresponding to the attribute information is selected as a delete target. That is to say, a selecting signal is transmitted from the side controller operation detecting part 23 to the CPU 21 by rotating or oscillating and pushing operation of the side controller 13 so that CPU 21 selects a newly arrived mail corresponding to the attribute information on which the cursor 55 is positioned as a delete target.

If a cursor 55 is positioned to an attribute information which is not deleted as a delete target (a non-selected attribute information)(i.e. a focused state), the attribute information is colored with black background and with white letter, for example. While, if the non-selected attribute information is not in a focused state, the background is white and the letter is black, for example.

As described above, when, after given newly arrived mails aimed to delete are selected, an execute button 53 is tapped, the CPU 21 deletes a block of newly arrived mails aimed to delete by the tap operation from a memory part 22a. Instead of tapping operation of the execute button 53, a block of newly arrived mails aimed to delete may be delete by pushing the side controller 13 for a time longer than a predetermined time.

In FIG. 12, when an all selection button 51 is tapped, the CPU 21 selects all newly arrived mails as delete targets. When a selecting reverse button 52 is tapped, CPU 21 reverse all selected state of newly arrived mails. (That is, selection and non selection are reversed like a toggle.) Further, a cancel button 54 is tapped and the CPU 21 displayed a list of newly arrived mails shown in FIG. 11 on the liquid crystal panel 12.

As stated above, when a delete mode button, which is a selecting function button is tapped on the list screen page of newly arrived mails, the CPU 21 turns into delete mode so as to display a screen page of a list of delete mode newly arrived mails on the liquid crystal panel 12. Since CPU 21 further selects sequentially a mail to be selected from the screen page of a list of delete mode newly arrived mails as a selected newly arrived mail (i.e. a newly arrived mail aimed to be deleted), a plurality of given discontinuous newly arrived mails can be selected as delete targets. After that, when a execute button is tapped, the newly arrived mails are deleted from the memory part 22a which is a function of memory.

Further in delete mode, when an attribute information concerning the newly arrived information to be deleted is tapped on the screen page of a list of newly arrived mails in delete mode, a selecting signal is generated, whereby CPU 21 selects a newly arrive mail aimed to delete. A newly arrive mail aimed to delete as stated above can be selected also by the side controller 13 so that operationality is enhanced at mobile environment such as when a user goes out.

When a list of mails is selected to activate on the aforementioned mail top screen page, a screen page of a mail list is displayed. On the screen page of a list of mails, received mails, sent mails/reserved sending mails and draft mails are selectively displayed. That is, if a “received mail box” is selected on the screen page of a list of mails, the aforementioned list of attribute information for every mail regarding all received mails is displayed; if a “sending mail box” is selected, the aforementioned list of attribute information for every mail regarding all sent mails/reserved sending mails is displayed; and if a “draft” is selected, the aforementioned list of attribute information for every mail regarding all drafts mails on the way of writing. As explained in relation to FIG. 11, a mail can be opened by tap operation or by rotating or oscillating and pushing operation of the side controller 13. Likewise, as explained in relation to FIG. 12, when a screen page is changed to a delete mode by tap operation of the delete mode button, mails aimed to delete are selected by tap operation or side controller operation and the execute button is tapped, the mails aimed to delete can be deleted.

Though an example of deletion of mails is explained above, information other than mails can be deleted. For example, a list of various data stored in the memory part 22a or file data of application programs in themselves is displayed and targets to delete are selected by tap operation or side controller operation to be deleted. In addition, apart from deletion, an process corresponding to a predetermined mode (a predetermined process) can be executed by touch operation of the execute button after selecting information on a predetermined mode transferred by touching the selecting function button. For example, when the execute button is touched after information is selected, the selected information is copied from a memory to another file. Further, a file data can be automatically opened or activated by tap operation or rotating or oscillating and pushing operation of the side controller 13 on a list screen page such as a file data.

As described above, since a screen page of a list of attribute information, in which a selecting function button is displayed, is displayed and a screen page is transferred to a selecting mode by touching the selecting function button to select sequentially information from the screen page of a list of attribute information as a selected information in response to a selecting signal to select an information that is necessary to be selected, any given information can be selected so that operationality is effectively enhanced.

Since an execute button is displayed on a screen page of a list of attribute information in a selecting mode and a predetermined process is performed by pushing the execute button, the same process can be performed to a block of information so that operationality is effectively enhanced.

Since a selecting signal is generate by touching an attribute information to be selected on a screen page of a list of attribute information in a selecting mode, an information can be easily and effectively selected.

Since a selecting signal is generated by oscillating or pushing the control switch part which is supported so as to be capable of oscillating within a predetermined range and pushing, an information can be easily and effectively selected.

Since a display part is disposed on the most part of the front face of a case of an information terminal and control switch part is disposed at the side face of the case of the information terminal and the control switch part is supported so as to be capable of oscillating around an axis parallel to the side face and pushing to a direction orthogonal to the axis, an information can be easily and effectively selected even in mobile environment.

Since an attribute information selected in response to a selecting signal is colored different from a color of other attribute information, a user can effectively recognize a selected attribute information at a glance.

### Third Embodiment

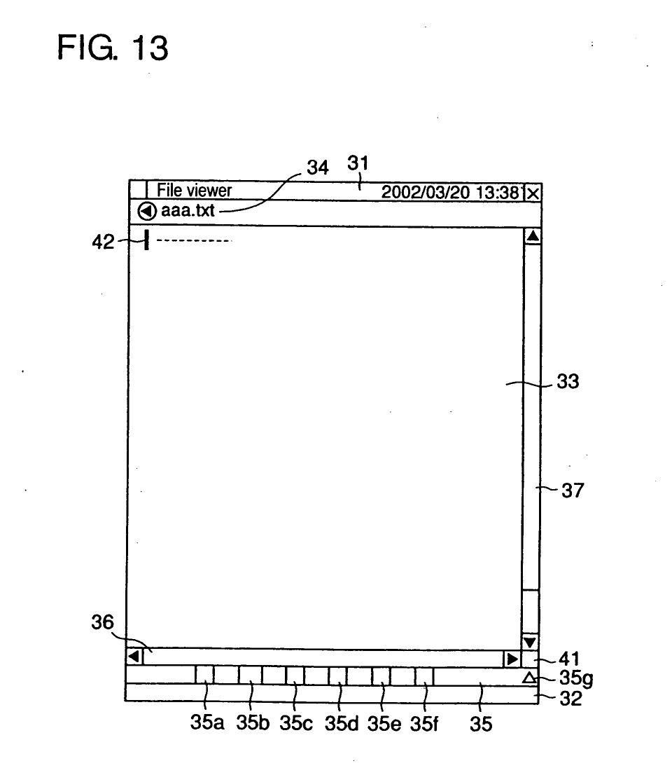

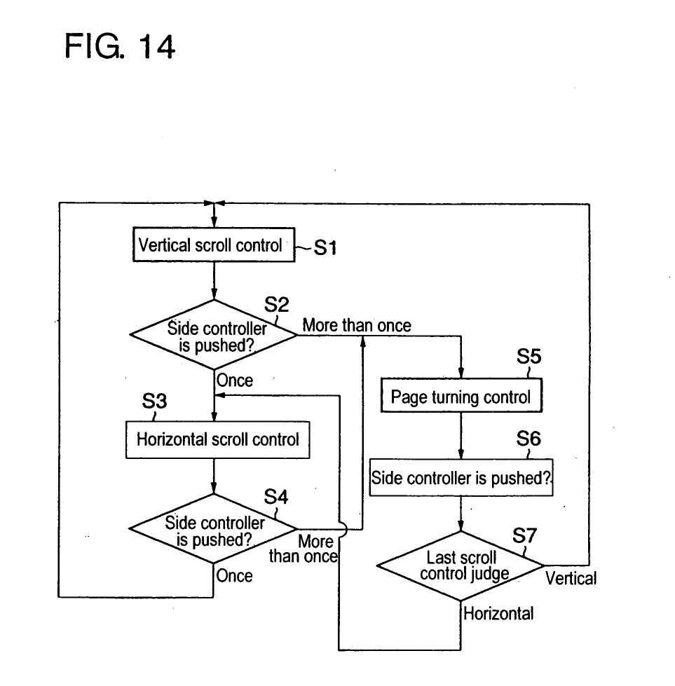

In a third embodiment of the present invention described below, constitutions of apparatuses and restricted conditions described by and shown in FIGS. 1, 2 and 8 in the first embodiment are the same as in the second embodiment unless otherwise specifically described. The explanation done in the first embodiment is to be replaced in the second embodiment as far as FIGS. 1, 2 and 8 are concerned, though the explanation in the third embodiment is omitted. It follows therefore that the third embodiment will be described by adding and referring to FIGS. 13 and 14.

In a launcher screen page shown in FIG. 8 which is displayed on a portable information terminal shown in FIG. 1, when a file viewer is selected by tap operation or side controller operation, a screen page of selecting file is displayed on a liquid crystal panel 12. When a requested file is selected from the screen page of selecting file by tap operation or side controller operation, a screen page indicative of a content of the file is displayed. A file herein denotes each mail file, each schedule file, each memo file, or other variety of files which are made by a PDA or a personal computer. These files are stored, for example, in memory part 22a.

Assuming that a file content shown in FIG. 13 is displayed on the liquid crystal panel 12 as a displayed screen page (a screen page displaying a file content), a title bar 31 and a task bar 32 are displayed on the displayed screen page of file content and a file content is displayed in a window displaying part 33; a file name 34 is displayed below the title bar 31 and a tool bar 35 is displayed above the task bar 32.

As an example shown in the figure, a horizontal scroll bar 36 is displayed above the tool bar 35 and a vertical scroll bar 37 is displayed in the right side of the window displaying part 33. The horizontal scroll bar 36 or the vertical scroll bar 37 is selectively displayed in compliance with the amount of the file content. That is, the CPU 21 displays a horizontal scroll bar 36 or a vertical scroll bar 37 in accordance with a size of the screen page.

As an example shown in the figure, the tool bar 35 has a mail attaching button 35a, an enlarging button 35b, a standard button 35c, a reducing button 35d, a page turning button (forward) 35e, a page turning button (backward) 35f, and a tool bar off button 35g as a function button. Page turning buttons 35e and 35f are displayed only when the file content has a plurality of pages.

When the mail attaching button 35a is tapped here, a file on consulting can be attached to a mail. When the enlarging button 35 is tapped, a file on consulting is enlarged to display. When the reducing button 35d is tapped, a file on consulting is reduced to display. When the standard button 35c is tapped, a file on consulting is displayed by predetermined ratio. (A file is displayed usually by standard ratio.)

When the page turning button 35e or 35f is tapped, a page is turned backward or forward. When the tool bar off button 35g is tapped, i.e. the tool bar 35 is turned off, the tool bar off button 35g is lighted on. When the tool bar off button 35g, which is lighted on, is tapped, the tool bar 35 is turned on so that tool bar off button 35 is turned off. The CPU 21 performs these controls.

When a file content overflows in both horizontal and vertical direction from a front page of the liquid crystal panel 12, the CPU 21 displays a horizontal scroll bar 36 and a vertical scroll bar 37. A scroll changing icon 41 is displayed on a screen page displaying a file content, the scroll changing icon 41 displays a scroll mode (a horizontal scroll mode and a vertical scroll mode) and a page turning mode. For example, in case of vertical scroll mode, an up and down arrow is displayed; in case of horizontal scroll mode, a right and left arrow is displayed; and in case of page turning mode, a diagonal arrow is displayed.

A vertical scroll mode and a horizontal scroll mode can be cyclically changed here also by tapping the scroll changing icon 41. A screen page is changed to a page turning mode mentioned later by double tap operation (consecutive two time tapping) of the scroll changing icon 41.

Now referring to FIG. 14 either, assuming that a vertical scroll mode is selected, the CPU 21 executes a vertical scroll control (step S1). If the side controller 13 is oscillated upwardly, the CPU 21 transfers the cursor 42 upwardly. In other words, the CPU 21 scrolls the window display part (the file content) upwardly. While, if the side controller 13 is oscillated downwardly, the CPU 21 transfers the cursor 42 downwardly so as to scroll the file content downwardly.

The side controller 13 is pushed once here(step S2), CPU 21 transfers from a vertical scroll mode to a horizontal scroll mode to perform a horizontal scroll control (step S3). When the side controller 13 is upwardly oscillated, the CPU 21 transfers the cursor 42 toward the left side to scroll a file content to the left. While, when the side controller is downwardly oscillated, the CPU 21 transfers the cursor 42 toward the right side to scroll a file content to the right.

Further, the side controller 13 is pushed once more (step S4), the CPU 21 transfers form a horizontal scroll mode to a vertical scroll mode to perform a vertical scroll control. Thus, every time the side controller 13 is pushed, the CPU 21 changes the horizontal scroll control to the vertical scroll control or vice versa.

In step S2 or S4, when the side controller 13 is pushed consecutively two times (so called double clicked), the CPU 21 transfers to a page turning mode to control a page turning control (step S5). In this mode, When the side controller 13 is upwardly oscillated, the CPU 21 changes a file content to the previous page; when the side controller 13 is downwardly oscillated, the CPU 21 changes a file content to the next page.

When the side controller is pushed once in the page turning mode (step S6), the CPU 21 returns to a scroll mode which is the last mode before the page turning mode. That is to say, the CPU 21 judges that the last scroll control is a vertical scroll control or a horizontal scroll control (step S7) so as to return to the last scroll control.

Though the above described is an example of transferring to a page turning mode by two consecutive pushing of the side controller 13, a method may be programmed so as to transfer sequentially to a horizontal scroll mode, a vertical scroll mode and a page turning mode.

Meanwhile, there is such a case that when a file content is within the size of a screen page displaying a file content, a horizontal screen control or a vertical scroll control is not necessary. In this case, the CPU 21 doesn't perform a horizontal scroll control or a page turning control. Namely, the CPU 21 executes at least one control of a vertical scroll control, a horizontal scroll control or a page turning control by oscillating operation in accordance with a size of a screen page of the file content displayed on the liquid crystal panel.

A kind of scroll control possible for a kind of file may be predetermined as a file content. In this case, as a vertical scroll control and a page turning control are possible for a document file such as a case of a word processor, a screen page is to be changed cyclically by pushing operation of the side controller 13.

In case, for example, of a image file, as only a vertical scroll control and a horizontal scroll control are possible, a screen page is to be changed cyclically by pushing operation of the side controller 13. In other words, according to a displayed mode, the direction possible for scroll control is univocally determined such as to a horizontal and a vertical, a horizontal only, a vertical only, a horizontal, a vertical and a page turning or a vertical and a page turning so that operationality is furthermore enhanced.

As apparent from the above explanation, the side controller 13 and the CPU 21 function as a switch part and a scroll control means respectively. The side controller 13 and CPU 21 constitute a screen page display controlling device.

Though a portable information terminal is explained as an example above, the scheme is also applicable for other information processing apparatus such as a personal computer. A switch part is provided to a mouse instead of the side controller 13 and a CPU of the personal computer performs scroll control and page turning control in response to operation of the switch part.

Though a scroll action at the activated state of the application soft ware of a file viewer shown in FIG. 13 is explained in the above example, the present invention is not restricted to the above example. The present invention can be applied to an activated state of various kinds of application soft wears and scroll actions of screen pages under all displaying states.

Though a case of using the side controller 13 mainly as a scroll control is explained in the above example, the pushing operation of the side controller 13 has at least two functions of a change of scroll control and a selective indication of item selecting indication on the menu screen page. Therefore, a function of pushing operation of the side controller 13 is varied automatically in accordance with variety of states such as a state of the PDA, a state of a displayed screen page and an application activated so that operationality is greatly enhanced.

Though a case of scrolling a page is explained as an above example, the present invention is not restricted to the above example. According to the present invention, a cursor displayed on a screen page can be moved so that a cursor control having extreme operationality is possible.

As described above, since a changing control of changing a horizontal scroll and a vertical scroll every time the switch is pushed, a control of changing scroll direction is easily performed so that operationality is effectively enhanced.

Further, since a horizontal scroll control or a vertical scroll control is performed corresponding to rotating or oscillating operation of the switch, a horizontal scroll or a vertical scroll is effectively performed.

Since a cursor is moved on a screen page in accordance with a direction of rotating or oscillating operation, a moving direction of switching operation is matched with that of a cursor, a user can operate easily.

Since a page turning control is performed on a screen page by consecutive pushing of predetermined times, a horizontal scroll control, a vertical scroll control or a page turning control can be changed only by pushing operation of the switch so that operationality is effectively enhanced.

Since a screen page is turned to the previous page or to the next page by rotating or oscillating of the switch, an operation of the switch can be accord with a direction of page turning so that a user can effectively operate.

Since at least one of a horizontal scroll control, a vertical scroll control or a page turning control is performed by rotating or oscillating operation of the switch in accordance with a screen page displayed on the display part, a horizontal scroll control, a vertical scroll control or a page turning control is selectively performed corresponding to a size of a displayed screen page, a user needs not to select a control among a horizontal scroll control, a vertical scroll control and a page turning control in each case depending on the size of a screen page so that operationality is effectively enhanced.

Since an information terminal is, for example, a portable information terminal wherein a switch is supported to an axis which is extended in a predetermined direction and to be capable of rotating or oscillating around the axis from a standard position within a predetermined range while the switch is capable of pushing at a standard position in a direction orthogonal to the direction of rotating or oscillating, the terminal is easily and effectively operated at a mobile environment.

Since a display part is disposed through on approximately all of a front face of a case of the portable information terminal and a switch is disposed at a side of the case with a predetermined direction in a direction from a front face to a back face, the switch is operated with a single hand, scroll control and page turning control can be easily and effectively operated.

### Fourth Embodiment

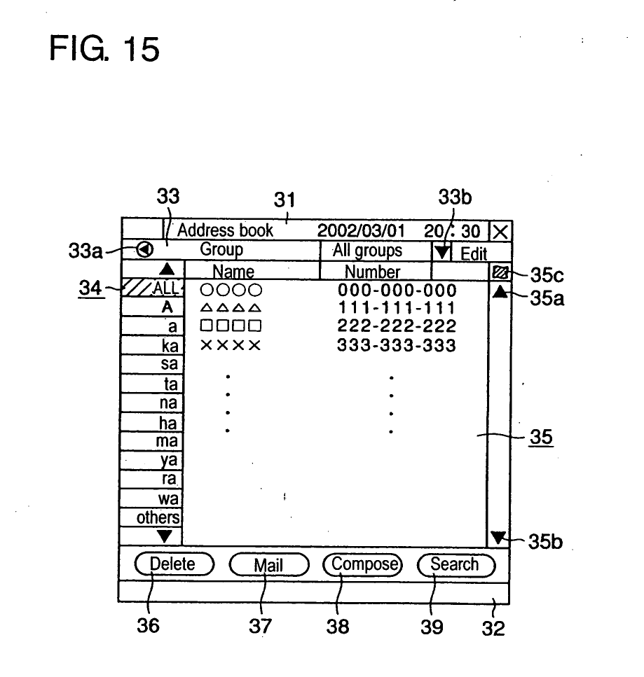

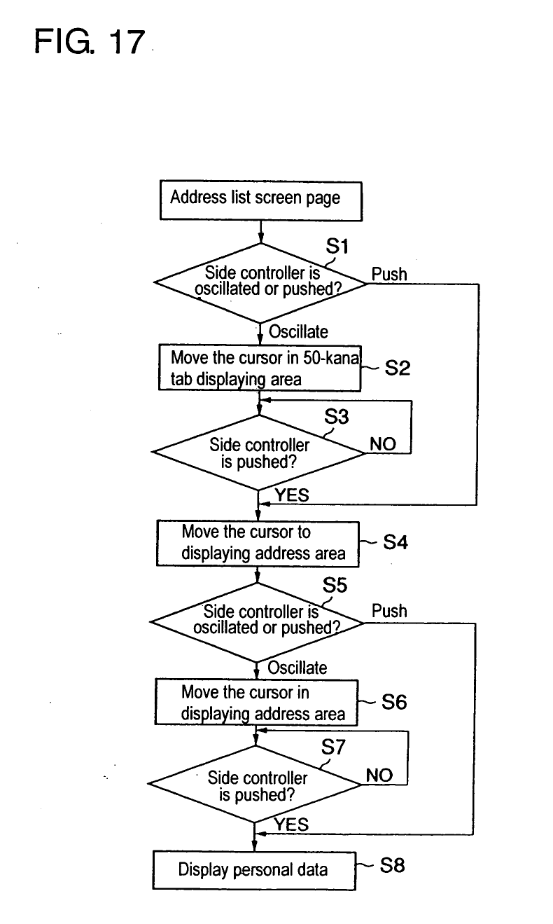

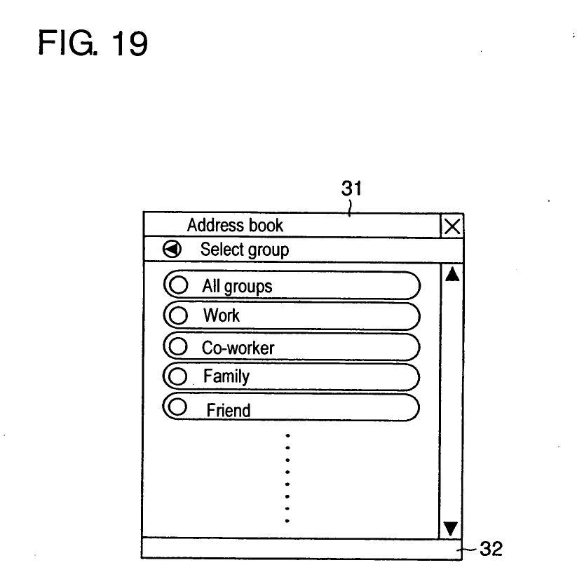

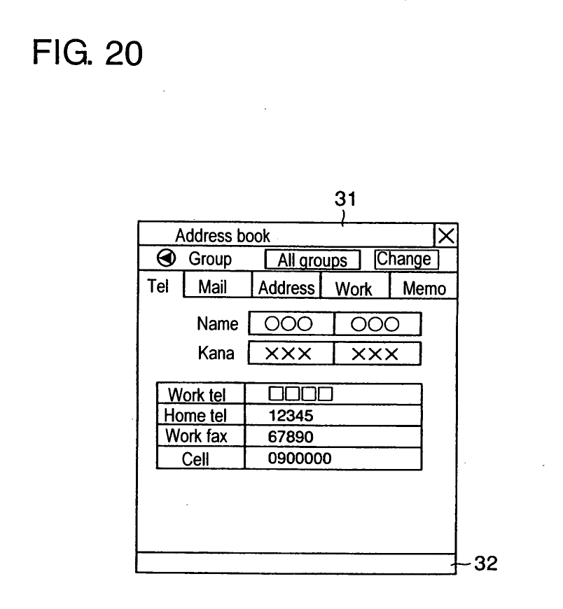

In a fourth embodiment of the present invention described above, constitutions of apparatuses and restricted conditions described by and shown in FIGS. 1, 2 and 8 in the first embodiment are the same as in the forth embodiment unless otherwise specifically described. The explanation done in the first embodiment is to be replaced in the second embodiment as far as FIGS. 1, 2 and 8 are concerned, though the explanation in the forth embodiment is omitted. It follows therefore that the second embodiment will be described by adding and referring to FIGS. 15 to 20.

When an address book is selected to activate on a launcher screen page shown in FIG. 8 displayed in a portable information terminal shown in FIG. 1 by tap operation or operation of a side controller, a CPU 21 displays a screen page of a list of addresses on a liquid crystal panel 12. As shown in FIG. 15, a title bar 31 and a task bar 32 are displayed. A group name column 33 is defined below the title bar.

An item displaying area 34 is defined below the group name column 33 along up and down direction in the figure (a first arraying direction). A plurality of items are arrayed in the item displaying area 34. Tabs of the 50-character kana syllabary are arrayed as items. Tabs of the 50-character kana syllabary consist of “ALL”, “A (alphabet)”, “a (a-line)”, “ka (ka-line)”, . . . , “wa (wa-line)” and “others”. (The item displaying area is herein after referred to as a display area of tabs of the 50-character kana syllabary 34)

An information displaying area 35 is defined at the right side of a display area of tabs of the 50-character kana syllabary 34. Information linked to the tab selected in the display area of tabs of the 50-character kana syllabary 34 (linked information) is displayed in the information displaying area 35. (In case there is no information linked to the selected tab, nothing is displayed.) A linked information herein is an information which is very related to the selected tab as if the information were strung with a string. As shown in the figure, names and points of contact are displayed as a linked information. (The information displaying area is hereinafter referred to as an address displaying area and names and points of contact as addresses.)

A delete button 36, a mail button 37, a creat button 38 and a search button 39 are displayed above the task bar 32.

When a return icon 33a in the group name column 33 is tapped, CPU 21 displays a group selecting screen page shown in FIG. 8 on the liquid crystal panel 12. For example, all groups, company, colleague, family, friend and others are displayed as group names. When one of the group names is selected by operation of the side controller, the CPU 21 returns to the screen page of a list of addresses and a selected group is displayed on the group name column 33.

As for a group selecting screen page, a requested group name may be selected from a group list by tap operation or operation of the side controller after calling the group list by tapping a group selecting list button 33b provided in the group name column 33.

Assuming that all group is selected as a group name as shown in FIG. 3, when “ALL” is tapped in the display area of tabs of the 50-character kana syllabary 34, “ALL” is selected as a selected tab so that the CPU 21 displays all addresses in the address displaying area 35 by searching an address book stored in the memory part 22a. In this regard, each address is displayed in a right and left direction (a second direction) and a plurality of addresses are sequentially arrayed in an-up and down direction (the first direction). The selected tab is reversely colored such as black.

As apparent from the above explanation, when “a-line” is tapped in the display area of tabs of the 50-character kana syllabary 34 so that addresses belonging to a-line of the address book are displayed in the address displaying area 35 by searching the address book stored in the memory part 22a. (See FIG. 4. When other tab is selected, addresses are displayed likewise.)

When a scroll button 35a or 35b which is provided at upper end or lower end of the display area of tabs of the 50-character kana syllabary 34 is tapped, a cursor moves upward and downward.

When detailed information regarding an address of addresses displayed in the address displaying area 35 is to be consulted, the CPU 21 displays detailed information (personal data) stored in the address book concerning the selected address on the liquid crystal panel 12 by tapping the address displayed in the address displaying area. That is, detailed information linked to the selected address is displayed on the liquid crystal panel 12.

When a scroll button 35a or 35b which is provided in the address displaying area 35, the address displaying area 35 is scrolled upward or downward.

When a delete button 36 is tapped, the CPU 21 deletes personal information pointed by the cursor together with personal data from the address book. When a mail button 37 is tapped, the CPU 21 activates a mail function using a mail address in the personal data corresponding to the presently selected address. When a creating button 38 is tapped, the CPU 21 displays a screen page of editing the address book on the liquid crystal panel 21 so as to be able to create a new personal data. When a search button 39 is tapped, a screen page of searching the address book is displayed so as to be able to search the address book using the screen page of searching.

Detailed explanation is omitted with regard to these functions. A changing display button 35cis provided in the displaying address area 35 so as to be able to change a contact point in the displaying address area 35 to, for example, a company name. Although a variety of function buttons are provided, explanation with this regard is omitted.

Selection of address or consulting of personal data by the aforementioned tap operation is bothersome. As a PDA used in a mobile environment needs to be handled with a single hand, tapping operation for selecting address or consulting personal data is extremely bothersome. According to the present embodiment, the CPU 21 selects address or consults personal data by operation of the side controller.

Referring to FIG. 15-17, when a launcher page is changed to a list page of address, a cursor is positioned to the display area of tabs of the 50-character kana syllabary 34. When a screen page of a list of addresses is displayed, the CPU 21 judges whether the side controller has been oscillated or pushed or not (step S11).

When the CPU 21 judges the side controller 13 has been oscillated, the CPU 21 moves the cursor up and down in answer to the oscillating direction of the side controller 13 (step S12). When a tab to which the cursor is positioned has an address, at least address is displayed in accordance with the movement of the cursor.

Next, the CPU 21 judges whether the side controller 13 has been pushed or not (step S13). When the CPU 21 judges the side controller 13 has been pushed, the CPU 21 moves the cursor to a tab of the upper most step in the displaying address area 35 from the tab where the cursor is positioned (step S14).

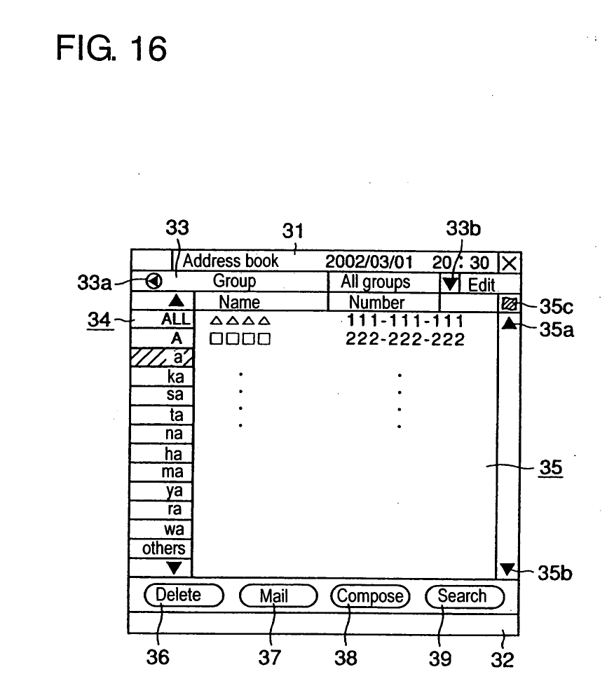

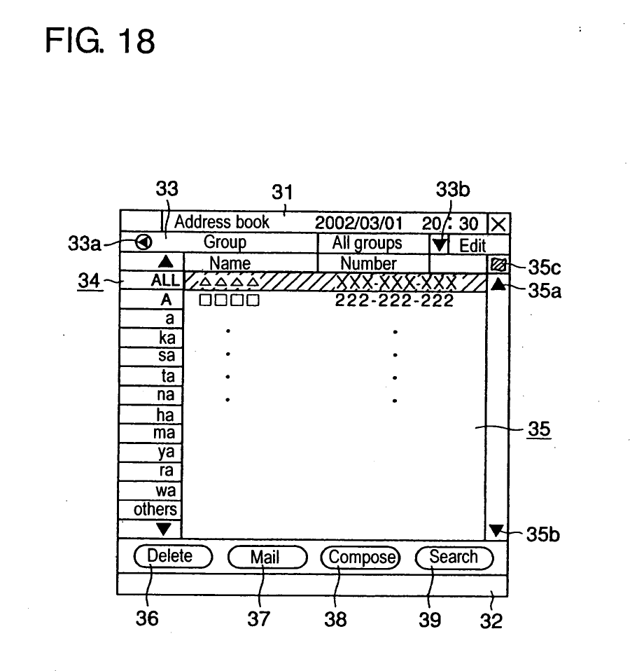

For example, as shown in FIG. 16, when the side controller 13 is pushed as the cursor is positioned to “a-line”, the CPU 21 moves the cursor to the displaying address area 35 where addresses linked to “a-line” is displayed and positions the cursor to the top address in the displaying address area 35. (See FIG. 18. When there is no address, the cursor does not move.) When the cursor moves to the displaying address area 35, a color of the relevant tab is changed.

After that, the CPU 21 judges whether the side controller 13 is oscillated, pushed or not (step S15). If the CPU 21 judges that the side controller 13 is oscillated, the CPU 21 moves the cursor up and down in the displaying address area 35 in answer to the direction of the oscillation of the side controller 13 (step S16).

Next, the CPU 21 judges whether the side controller 13 has been pushed or not (step S17). When the CPU 21 judges the side controller 13 has been pushed, the CPU 21 displays personal data (see FIG. 9) stored in the address book concerning the address which the cursor is positioned to (the selected address) on the liquid crystal panel 12 (step S18).

Meanwhile, the CPU 21 judges that the side controller 13 is pushed in step S11, the CPU 21 transfers to step S14. In this occasion, as mentioned above, as the cursor is positioned to “ALL” in the display area of tabs of the 50-character kana syllabary 34, all addresses are displayed in the displaying address area 35.

Further, the CPU 21 judges that the side controller 13 is pushed in step S15, the CPU 21 transfers to step S18. In this occasion, as mentioned above, as the cursor is moved to the top address of the displaying address area 35, the CPU 21 displays personal data corresponding to the top address on the liquid crystal panel 12 by reading out from the address book.

In this manner, when the a screen page of a list of addresses is displayed, the CPU 21 moves the cursor up and down in the display area of tabs of the 50-character kana syllabary 34 by oscillating the side controller 13; the CPU 21 moves the cursor to the displaying address area 35 from the display area of tabs of the 50-character kana syllabary 34 by pushing the side controller 13.

Further, when the side controller is oscillated, the CPU 21 moves the cursor in answer to the oscillating direction in the displaying address area 35; when the side controller 13 is pushed, the CPU 21 displays personal data corresponding to the address to which the cursor is positioned on the liquid crystal panel 12. (See FIG. 9).

As a result, only by operating the side controller 13, selection of tabs of the 50-character kana syllabary and addresses and consultation of personal data are possible. That is, by a simple operation, tabs of the 50-character kana syllabary and addresses can be selected and personal data can be consulted so that operationality can be enhanced.

Besides, when the cursor is positioned on the display area of tabs of the 50-character kana syllabary 34 in a screen page of a list of addresses, the CPU 21 displays the aforementioned group selecting screen page by pushing an escape switch 14. When the cursor is positioned on the displaying address area 35, the CPU 21 returns the cursor to the display area of tabs of the 50-character kana syllabary 34 by pushing an escape switch 14.

A case was explained above as an example that tabs of the 50-character kana syllabary and addresses were selected and personal data were consulted on a screen page of a list of addresses such as an address book by operating the side controller 13. Likewise, items and information can be selected and detailed information can be consulted not only on the address book but also on a screen page capable of defining an item displaying area in which a plurality of items are arrayed and an information displaying area which displays information linked to the selected item as a linked information when an item is selected as a selected item.

As apparent from the above explanation, such a program for processing displaying information that the CPU 21 functions as an item selecting control means, a transferring control means, an information selecting means and a detailed information displaying control means and these functions are executed on the CPU 21 may be run.

As described above, since after a selected item is selected from a plurality of items by moving a cursor on an item displaying area in answer to oscillating operation of a control switch part, the cursor is transferred to an information displaying area from an item displaying area by pushing operation of the control switch part, an item and linked information are easily selected with easy operation that is, only by operating the control switch part so that operatinality is enhanced.

Since, when the cursor is moved to the information displaying area from the item displaying area, one of linked information is selected as a selected linked information by moving the cursor on the information displaying area in answer to oscillating operation of the control switch part, a linked information can be selected with easy operation.

Further, since a detailed information further linked to the selected linked information is displayed on a screen page by pushing operation of the control switch part after selecting a linked information, a detailed information is easily consulted with simple operation.

Since a plurality of items are arrayed on a screen page in a first direction and linked information are displayed on the screen page along a second direction orthogonal to the first direction, a user can visually recognize a relationship between the item and the linked information.

Further, since, when there are a plurality of linked information, a plurality of linked information are arrayed along a first direction, a user can visually recognize a relationship between the item and the linked information.

Since the first arraying direction above is the same direction as a direction of oscillation of the control switch part, a moving direction of the cursor is accord with an oscillating direction so that operationality is enhanced.

Since a control switch part is supported with an axis extending to a predetermined direction so as to be capable of oscillating within a predetermined range from a predetermined standard position around the axis and capable of pushing at a standard position to the direction orthogonal to the oscillating direction, the control switch part can be operated with a single hand so that operationality is enhanced.

Since a display part is disposed on the most pat of the front face of a case of an information terminal and a control switch part is disposed on the side face of the information terminal in a predetermined direction of the direction from the front face to the back face of the case of the information terminal, a relationship of disposed position between the display part and the control switch part is convenient for a user so that operationality is enhanced.

As explained above, related information linked to each other may be, for example, telephone book information such as telephone number, address, date of birth, age, occupation and sex, which are related to a personal name or, for example, patent filing information such as publication number, registration number, application date, applicant name, inventor name and title, which are related to an application number. Further, it maybe, for example, file information such as file size, file creation date, file category and creator's name, which are attribute information related to a file name. According to the present invention, interactively linked information is not restricted to such information as telephone book information, patent filing information or file information. Interactively linked information contains widely related information as if the information were linked to certain information with a string. Further, linked information contain so-called attribute information.

1. An information terminal comprising:
a control switch part capable of oscillating operation or rotating operation and pushing operation; and
a display part displaying a plurality of items,
wherein one item is sequentially selected from the items every time the control switch is pushed.

2. An information terminal according to claim 1, wherein a plurality of the items are a plurality of tabs arrayed in a predetermined direction and a tab is sequentially selected along the predetermined direction every time the control switch is pushed.

3. An information terminal according to claim 1, wherein a tab is selected along the right and left direction by pushing operation of the control switch part and a cursor is transferred to at least one item of the selected tab by oscillating operation or rotating operation of the control switch part so as to select a selected item by pushing operation of the control switch part at the position of the cursor.

4. An information terminal according to claim 1, wherein the display part displays a plurality of items as a two dimensional array, and comprising:
a first selection control means selecting one item from a plurality of the items along one direction of the two dimensional array by oscillating operation or rotating operation of the control switch part; and
a second selection control means selecting one item along other direction of the two dimensional array by pushing operation of the control switch part.

5. An information terminal according to claim 4, wherein the plurality of the items are a plurality of tabs, the first selection control means selects sequentially the tab along up and down direction every oscillating operation or rotating operation of the control switch part and the second selection control means selects sequentially the tab along right an left direction every pushing operation of the control switch part.

6. An information terminal comprising:
a control switch part capable of oscillating operation or rotating operation and pushing operation;
a display part capable of displaying a first screen page displaying a plurality of items as a one-dimensional array and second screen page displaying a plurality of items as a two-dimensional array;
a first selection control means selecting one item from a plurality of the items along the direction of the array on the first screen page by oscillating operation or rotating operation of the control switch part;
a second selection control means selecting one item from a plurality of the items along one direction of the array on the second screen page by pushing operation of the control switch part; and
a transfer means transferring the first screen page by means of pushing operation of the control switch part to the screen page related to the item selected by oscillating operation or rotating operation of the control switch part.

7. An information terminal according to claim 6, wherein:
the first screen page is a menu page consisting of a plurality of menu items; the second screen page is a page consisting of a plurality of tabs;
the first selection control means selects sequentially the menu item along up and down direction every oscillating operation or rotating operation of the control switch part;
the second selection control means selects sequentially the tab along right and left direction every pushing operation of the control switch part; and
the transfer means transfers a screen page by means of pushing operation of the control switch part to the screen page related to the menu item selected by oscillating operation or rotating operation of the control switch part.

8. An information terminal according to claim 5 or 7, comprising a tab transfer means which transfers a screen page on which a plurality of tabs are displayed to a screen page related to the tab selected by pushing operation of the control switch part for a time longer than a predetermined time in the state that a plurality of said tabs are displayed on the display part.

9. An information terminal according to claim 1, wherein the control switch part is capable of oscillating operation within a predetermined range and is capable of pushing operation only at the approximately center position of the predetermined range.

10. An information terminal capable of storing at least one information and displaying a list of attribute information which discriminates the stored information on a display part comprising:
a first mode which displays or activates an information corresponding to the attribute information pointed by arbitrarily pointing an attribute information from the list of attribute informations;
a second mode adding sequentially as a candidate an information corresponding to the attribute information pointed sequentially by arbitrarily pointing an attribute information; and
a mode selection means for selectively changing the first mode to the second mode or vise versa,
wherein the same process is executed in one lump for at least one information pointed as a candidate on the second mode by predetermined pointing operation.

11. An information terminal capable of storing at least one information and displaying a list of the stored information on a display part according to claim 10, comprising:
a control switch part capable of oscillating or rotating and pushing;
a third mode which displays or activates an information selected by pushing operation of the control switch part after selecting an information on the list of the stored information by oscillating or rotating operation of the control switch part; and
a forth mode which adds sequentially the information selected as a candidate by pushing operation of the control switch part after selecting an information on the list of the stored information by oscillating or rotating operation of the control switch part and deletes all of the added candidate information by predetermined other operation,
wherein the third mode and the forth mode can be selectively changed each other.

12. An information terminal having a touch panel and capable of displaying e-mails as a list on the touch panel according to claim 10, comprising:
a fifth mode which transfers the list screen page to a screen page displaying contents of the e-mail touched by touch operation to an e-mail on the list page; and
a sixth mode which adds sequentially the selected e-mail as a candidate by touch operation to an e-mail on the list of the e-mails and deletes all of the added candidate e-mails by predetermined touch operation,
wherein the fifth mode and the sixth mode can be selectively changed each other by touch operation.

13. An information terminal capable of displaying a list of stored e-mails received on a display part according to claim 10, comprising:
a control switch part capable of oscillating or rotating and pushing;
a seventh mode which selects an e-mail on the list page of the e-mails by oscillating or rotating operation of the control switch part and transfers to a screen page displaying contents of the selected e-mail by pushing operation of the control switch part; and
an eighth mode which selects an e-mail on the list page of the e-mails by oscillating or rotating operation of the control switch part and after adding sequentially the selected e-mail as a candidate by pushing operation of the control switch part, deletes all of the added candidate e-mails by predetermined other operation,
wherein the seventh mode and the eighth mode can be selectively changed each other.

14. A program for processing displaying information which is programmed to run on an information terminal capable of storing at least one information and displaying a list of attribute information discriminating the stored information on a display part, comprising:
a first step which displays or activates an information corresponding to the attribute information pointed by pointing operation to an attribute information on the list page of the attribute information;
a second step which adds sequentially an information corresponding to a pointed attribute information as a candidate by sequential pointing operation to an attribute information on the list page of the attribute informations;
a mode selection step which changes selectively the first step and the second step each other; and
a processing step which executes the same step in a lump for at least one information added by the second step as a candidate.

15. A program for processing displaying information which is programmed to run on an information terminal capable of storing at least one information and displaying a list of the stored information according to claim 14, comprising:
a third step which selects an information on the list of the information by oscillating or rotating operation of a control switch part capable of oscillating or rotating and pushing and displays or activates the selected information by pushing operation of the control switch part;
a forth step which selects an information on the list of the information by oscillating or rotating operation of the control switch part, adds a selected information sequentially as a candidate by pushing operation of the control switch part and delete all of the sequentially added candidate information by predetermined other operation; and
a changing step which changes selectively the third step and forth step each other.

16. An information terminal having a display control means displaying a screen page on a display part comprising:
a switch capable of oscillating or rotating operation and pushing operation;
a horizontal scroll control means which scrolls the screen page in the horizontal direction by oscillating or rotating operation of the switch; and
a vertical scroll control means which scrolls the screen page in the vertical direction by oscillating or rotating operation of the switch,
wherein the horizontal scroll control means and the vertical scroll control means are selectively activated each other every pushing operation of the switch.

17. An information terminal having a display control means displaying a screen page on a display part according to claim 16, comprising:
a page turning control means which turn the screen page by oscillating or rotating operation of the switch; and
a control changing means which activates alternatively at least two control means of the horizontal scroll control means, the vertical scroll control means and the page turning control means every pushing operation of the switch..

18. An information terminal having a display control means displaying a screen page on a display part according to claim 16, comprising:
a page turning control means which turn the screen page by oscillating or rotating operation of the switch; and
a second control changing means which activates alternatively at least two control means of the horizontal scroll control means, the vertical scroll control means and the page turning control means by pushing operation of the switch; and
a control change restricting means which restricts a control means changeable by the second control changing means on the screen page displayed on the display part.

19. An information terminal having a display control means displaying a screen page on a display part according to claim 18, wherein the control change restricting means restricts in accordance with a size or a kind of the screen page.

20. An information terminal having a display control means displaying a screen page on a display part according to claim 16, wherein a menu screen page which displays a plurality of menu items can be displayed and an menu item is selected from a plurality of the menu items displayed on the menu screen page by oscillating or rotating operation in case of a displayed screen page is the menu screen page and a screen page is transferred by the pushing operation of the switch to the screen page corresponding to the selected menu item.

21. An information terminal having a display control means displaying a screen page on a display part according to claim 16, wherein a cursor can be displayed on the display part, the cursor moving in the horizontal or vertical direction instead of scrolling horizontally or vertically the displayed screen page by said horizontal or vertical scroll control means.

22. A program for processing displaying information which is programmed to run on an information terminal displaying a screen page comprising:
a horizontal scroll controlling step which scrolls horizontally the displayed screen page by oscillating or rotating operation of a switch capable of oscillating or rotating and pushing;
a vertical scroll controlling step which scrolls vertically the displayed screen page by oscillating or rotating operation of the switch; and
a changing step which activates selectively the horizontal scroll controlling step and vertical scroll controlling step every pushing operation of the switch.

23. A program for processing displaying information which is programmed to run on an information terminal displaying a screen page comprising:
a horizontal scroll controlling step which scrolls horizontally the displayed screen page by oscillating or rotating operation of a switch capable of oscillating or rotating and pushing;
a vertical scroll controlling step which scrolls vertically the displayed screen page by oscillating or rotating operation of the switch;
a page turning control step which turns the screen page by oscillating or rotating operation of the switch; and
a control changing step which activates alternatively at least two control steps of the horizontal scroll control step, the vertical scroll control step and the page turning control step every pushing operation of the switch.

24. A program for processing displaying information which is programmed to run on an information terminal displaying a screen page according to claim 23, comprising:
a second control changing step which activates alternatively at least two control steps of the horizontal scroll control step, the vertical scroll control step and the page turning control step every pushing operation of the switch; and
a control change restricting step which restricts a control step changeable by the second control changing step on the screen page displayed on the display part.

25. An information terminal comprising a display controlling means capable of displaying at least one part of a plurality of items on a display part, the display controlling means further comprising:
an item selecting means which selects an item from a plurality of items;
an item determining means which determines the selected item; and
an instructing means which instructs to display related informations linked to a plurality of related information groups,
wherein at least one part of related informations of the related information groups related to the item determined by the item selecting means and the item determining means is displayed on the display part and another related information is displayed instead of at least one part of related information on display by the instructing means.

26. An information terminal according to claim 25, comprising a switch part capable of oscillating or rotating and pushing operation, wherein:
the item selecting means selects an item from a plurality of items by oscillating or rotating operation of the switch part;
the item determining means determines the selected item by pushing operation of the switch part; and
the instructing means instructs to display the related information linked to the related group of the determined information by pushing operation of the switch part at least after determining operation of the item by the switch part.

27. An information terminal according to claim 25, comprising:
a switch part capable of oscillating or rotating and pushing operation;
a display part capable of displaying various types of information by oscillating or rotating and pushing operation of the switch part; and
a related information group display controlling means which displays on the display part a related information group consisting of a plurality of related informations linked each other and to the related information group,
wherein the related information group display controlling means displays sequentially on the display part a plurality of related informations linked to the related information group every pushing operation.

28. An information terminal comprising:
an item displaying area which displays a plurality of items;
a related information displaying area which displays related informations of a plurality of related information groups related to the plurality of items;
an item selecting means which selects an item from a plurality of the items by putting a cursor thereon;
an item determining means which determines the selected item, an instructing means which instructs to display related informations linked to the related information group; and
a display controlling means which, in case an item of the item displaying area is determined by the item selecting means and the item determining means, displays at least one part of related information groups related to the determined item on the related information displaying area and, transferring a cursor to the related information displaying area, displays another linked related informations on the related information displaying area with the instructing means instead of at least one related information on display.

29. An information terminal according to claim 25, wherein said item is displayed as an array in a first direction on a screen page of the display part and said related information is displayed as an array in a second direction which is approximately orthogonal to the first direction on a screen page of the display part.

30. An information terminal according to claim 25, wherein the related information group is information of an address book consisting of a plurality of personal data information and the linked related information is personal data information such as names, telephone numbers and addresses.

31. An information terminal according to claim 25, comprising:
a switch part capable of oscillating or rotating and pushing operation;
a display area of tabs of the 50-character kana syllabary which displays tabs of the 50-character kana syllabary;
a display area of personal information which displays linked personal data for a plurality of persons consisting of at least personal names, telephone numbers and addresses; and
a means for selecting tabs of the 50-character kana syllabary which selects a kana character tab from the tabs of the 50-character kana syllabary by oscillating or rotating operation of the switch part,
wherein at least personal name data of personal data of personal names which begin with the kana letter selected by pushing operation of the switch part are displayed on the display area of personal information and other linked personal data is displayed on the display area of personal information every pushing operation of the switch part.

32. A program for processing displaying information which is programmed to run for a display controlling means comprising the steps of:
displaying at least a part of a plurality of items on a display part;
selecting an item from a plurality of the items;
displaying at least one part of linked related informations of a plurality of related informations groups, the related information group having a plurality of related informations linked to each other and to the related information group; and
displaying other linked related information instead of at least one part of the related informations on display by instruction to display linked related informations of the related information group.

33. A program for processing displaying information which is programmed to run for a display controlling means according to claim 32, comprising the steps of:
displaying on a display part at least one related information of the related information group by operation of a switch part capable of oscillating or rotating and pushing operation; and
displaying sequentially on the display part a plurality of related informations linked to the related information group every pushing operation of the switch.

34. A program for processing displaying information which is programmed to run for a display controlling means according to claim 32, comprising the steps of;
selecting an item on an item displaying area of a display part displaying a plurality of items by oscillating or rotating operation of a switch part capable of oscillating or rotating and pushing operation;
displaying a part of linked related informations of the related information group related to the selected item among a plurality of related information groups on the related information displaying area by pushing operation of the switch part; and
displaying other linked related information on the related information displaying area by pushing operation of the switch part instead of at least one related information on display by pushing operation of the switch part.

35. A program for processing displaying information which is programmed to run for a display controlling means according to claim 32, comprising the steps of:
selecting one kana character tab from tabs of the 50-character kana syllabary displayed on a tabs of the 50-character kana syllabary displaying area of a display part by oscillating or rotating operation of the switch part;
displaying at least personal name data of personal data of personal names which begin with the selected kana character on a personal information area of the display part by pushing operation of the switch part; and
displaying other linked personal informationws on the personal displaying area every pushing operation.
